(19) United States
(12) Patent Application Publication
(10) Pub. No.: US 2014/0244998 A1
(43) Pub. Date: Aug. 28, 2014

(54) SECURE PUBLISHING OF PUBLIC-KEY CERTIFICATES

(71) Applicant: SECURE64 SOFTWARE CORPORATION, Greenwood, CO (US)

(72) Inventors: Jose Castejon Amenedo, Fort Collins, CO (US); Joe Gersch, Loveland, CO (US); William S. Worley, JR., Centennial, CO (US)

(73) Assignee: SECURE64 SOFTWARE CORPORATION, Greenwood, CO (US)

(21) Appl. No.: 14/169,102

(22) Filed: Jan. 30, 2014

Related U.S. Application Data
(63) Continuation-in-part of application No. 13/293,102, filed on Nov. 9, 2011, now abandoned.
(60) Provisional application No. 61/411,895, filed on Nov. 9, 2010.

(51) Int. Cl. H04L 9/32; H04L 29/06

(52) U.S. Cl. CPC H04L 9/3294; H04L 63/0823
USPC 713/156

(57) ABSTRACT

The current document is directed to methods and systems for secure provisioning, publication, distribution, and utilization of public-key certificates. These methods and systems employ domain name system (“DNS”) servers implementing the DNS security extensions (“DNSSEC servers”), a publisher component, and additional client-side and server-side functionalities. Public-key certificates provided by the DNSSEC servers engender a high degree of trust, as their integrity is protected and can be readily authenticated by the cryptographic-digital-signature based chains of trust provided by the DNSSEC. The systems to which the current document is directed employ DNSSEC servers, a publisher component, and additional client-side and server-side functionalities, and are referred to as “Public-key certificate Distribution and Management Systems” (“CDMSs”).

### CROSS-REFERENCE TO RELATED APPLICATION

This application is a continuation-in-part of application Ser. No. 13/293,102, filed Nov. 9, 2011.

### TECHNICAL FIELD

The current document is related to secure electronic communications, cryptography, and, in particular, to secure methods for provisioning, accessing, and utilizing public-key certificates.

### BACKGROUND

Significant developments in information science, cryptography, and electronic-communications hardware and software have led to advancements in secure communications that allow businesses, using commercial IT systems, as well as individuals, using personal computers, tablets, or smart phones, to securely exchange messages and files through generally unsecured public communications networks and systems, particularly the Internet. Many protocols for secure communications rely upon public/private-key-based cryptography, such as the RSA cryptosystem. Additional types of public/private-key-based cryptosystems, including those based on elliptic curves and other computationally difficult problems, have emerged more recently than the RSA cryptosystem.

While, in principle, public/private-key-based cryptographic methods can be widely used in protocols to securely transmit information between computers, the currently used methods for generation, distribution, and management of public keys among communicating individuals and computer systems present a variety of logistic, management, and conceptual problems that can frustrate both computer users and system administrators, constrain access to secure communications, and present security issues with respect to repeated and on-going secure communications.

### SUMMARY

The current document is directed to methods and systems for secure provisioning, publication, distribution, and utilization of public-key certificates. These methods and systems employ domain name system (“DNS”) servers implementing the DNS security extensions (“DNSSEC servers”), a publisher component, and additional client-side and server-side functionalities. Public-key certificates provided by the DNSSEC servers engender a high degree of trust, as their integrity is protected and can be readily authenticated by the cryptographic-digital-signature based chains of trust provided by the DNSSEC. The systems to which the current document is directed employ DNSSEC servers, a publisher component, and additional client-side and server-side functionalities, and are referred to as “Public-key certificate Distribution and Management Systems” (“CDMSs”).

### BRIEF DESCRIPTION OF THE DRAWINGS

FIG. 1 illustrates encryption and decryption processes.

FIG. 2 summarizes three basic encryption-based techniques.

FIG. 3 illustrates the structure of an RSA X.509 public-key certificate.

FIGS. 4A-F illustrate a basic, public/private-key-based secure information exchange between a user and a remote responder.

FIGS. 5A-B illustrate human-readable email-address resolution by the DNSSEC.

FIG. 6 illustrates the logical hierarchical organization of DNSSEC.

FIG. 7 illustrates additional subdomains and subzones of the “.acme” domain's corresponding zone.

FIG. 8 illustrates the types of information stored within the DNSSEC databases of DNSSEC servers.

FIG. 9 illustrates data flow to and from zone data managed within DNSSEC servers of a DNSSEC zone.

FIG. 10 illustrates an extension of DNSSEC used in the currently disclosed CDMS.

FIG. 11 illustrates additional components of the CDMS to which the current document is directed.

FIG. 12 shows components of the CDMS for a hypothetical Ajax Corporation.

FIG. 13 illustrates, using a control-flow diagram, a DNSSEC published-cert query carried out by a mail server or other DNSSEC publisher to retrieve a public-key certificate.

FIG. 14 illustrates resolution of a partial digital signature.

FIGS. 15A-D illustrate implementation of the create publisher functions.

FIG. 16 provides a block diagram of a generalized computer system on which components of the certificate distribution and management system are implemented.

### DETAILED DESCRIPTION

The current document is directed to systems that employ DNSSEC servers, a publisher component, and additional client-side and server-side functionalities, and that are referred to as “Public-Key Certificate Distribution and Management Systems” (“CDMSs”) as well as to methods carried out within and by CDMSs. The currently described methods and systems provide for the management and utilization of public keys, security of communication protocols, and innovation opportunities for new secure functionalities and services that address an ever-growing need for secure and trustworthy communications. The currently described methods and systems are effectively and easily used to safely and securely generate and publish public keys and ensure that the generated public keys can be securely authenticated when received, immediately revoked and replaced, and prevent various types of attacks and ameliorate many potential security breaches that have been identified in many currently used systems and methods.

In the following discussion, an overview of public/private-key-based cryptography and public-key certificates is first provided, followed by a discussion of potential security breaches that may occur, despite use of protocols and methods that employ public/private and symmetric key-based cryptography to encrypt information prior to transmission through public communications networks. Next, an overview of network protocols and the DNS and DNSSEC is provided. Finally, following these initial discussions, methods, and systems to which the current document is directed are disclosed with reference to illustrations and control-flow diagrams.

### Overview of Public/Private-Key-Based Cryptography and Public-Key Certificates

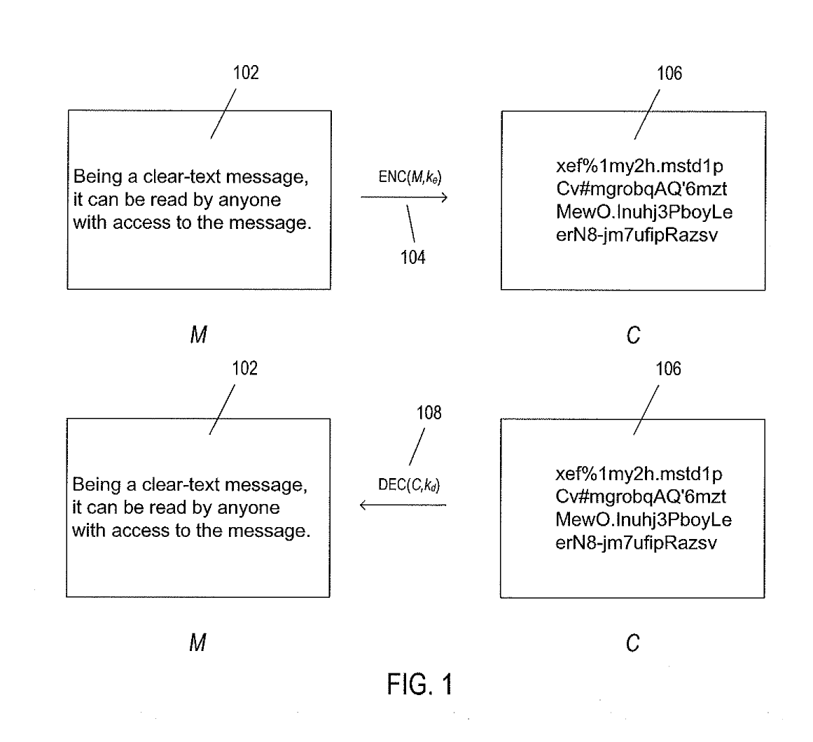

Encryption methods transform a digitally encoded sequence of symbols, including text and numerical data, into a corresponding encrypted symbol sequence that cannot be straightforwardly read or interpreted, in general, but that contains the same information that is contained in the original symbol sequence that was encrypted to produce the encrypted symbol sequence. A party possessing a decryption key or other decryption-facilitating information can carry out an inverse transformation to regenerate the original symbol sequence. FIG. 1 illustrates encryption and decryption processes. As mentioned above, encryption is used to transform a clear-text message or symbol string into encrypted form that cannot be interpreted by normal symbol-string interpretation algorithms, such as by reading natural-language statements. Decryption is the inverse process by which encrypted symbol strings are transformed back to clear-text form. In FIG. 1, an initial natural-language message M 102 is transformed, by encryption 104, to an encrypted message C 106. In the current discussion, the expression “ENC(M, kₑ)” stands for encryption of message M using encryption key kₑ. By comparing clear-text message M with encrypted message C, it is clear that the meaning of encrypted message C cannot be extracted by normal text-processing means. Instead, an encrypted message C needs to be first reverse-transformed back to a clear-text message by the decryption process 108. The expression “DEC(C, k_{d})” stands for decryption of encrypted message C using decryption key k_{d}. This can be alternatively expressed as “ENC⁻¹(C, k_{d}).”

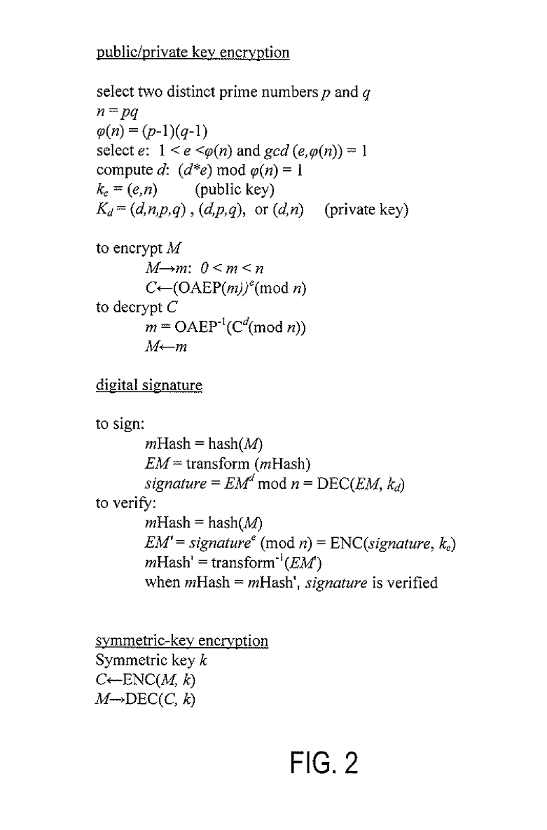

FIG. 2 summarizes three different encryption-based techniques referred to in the following discussions. Public-key/private-key encryption is widely used in commercial transactions and information-exchange protocols. One commercially successful public-key/private-key cryptosystem, also referred to as an “asymmetric” cryptosystem because different keys are used by the sender and the receiver, is named the “RSA” cryptosystem. The name RSA comprises the first letters of the last names of the inventors of the method: Ron Rivest, Adi Shamir, and Leonard Adleman. In this asymmetric cryptosystem, pairs of encryption/decryption keys are generated. In general, the encryption key is publically distributed, and referred to as the “public key,” while the decryption key is held in secret solely by the key-pair-owning, encrypted-message-receiving party, and is referred to as the “private key” or “secret key.” In normal usage, anyone can access the public key and encrypt a message using the public key, but only the receiving party in possession of the private key can decrypt and read the encrypted message.

For secure communications, two parties exchange their public encryption keys so that each party can encrypt a message and transmit the encrypted message to the other party for decryption and reading solely by the other party. However, because of the relatively high computational overhead for asymmetric cryptography, protocols such as the transport layer security (“TLS”) protocol and the secure socket layer (“SSL”) protocol usually begin a session with a handshake step in which public/private cryptography is used initially to establish a symmetric key that can be used more computationally efficiently for message encryption and decryption. Both parties use the symmetric key for the remainder of the session. The symmetric key is referred to as a “session key.”

To generate an encryption/decryption key pair for the RSA cryptosystem, two prime numbers p and q are first selected, and the product n=pq is computed and saved. Next, the function φ(n) is computed as (p−1)(q−1). Then, an integer e in the range (1, φ(n)) is selected such that the greatest common divisor of e and φ(n) is 1. A corresponding integer d is computed such that (d*e) mod φ(n)=1. The public encryption key kₑ is the pair of integers (e,n) and the private, or secret, decryption key k_{d} can be the four-tuple (d, n, p, q), the three-tuple (d, p, q), or the pair (d,n). To encrypt a message M, M is first transformed to an integer m in the range (0,n), the integer in is then subjected to the Optimal Asymmetric Encryption Padding (OAEP) randomized padding scheme, and the result is then raised to the power e modulo n or, as shown in FIG. 2:

C=(OAEP(m))^{e} mod n.

To decrypt the encrypted message C, the integer m is recovered by applying the inverse of the randomized padding scheme to the result of decrypting the message C by raising C to the power d modulo n, as shown in FIG. 2:

m=OAEP⁻¹(C^{d} mod n)

Finally, the integer m is transformed back into message M by the inverse of the forward transformation of M to m, performed as the first step of the encryption method. In certain cases, the initial transformation and final inverse transformations are omitted.

The RSA encryption/decryption method can also be used to digitally sign a message to provide authentication of the integrity of a transmitted message. Digital signing relies on the fact that, for a given initial value less than n, encryption is the inverse operation of the decryption operation, and vice versa. Digital signing proceeds as follows. First, a one-way cryptographic hash function is applied to the message M to produce a hash value, referred to as a “hash digest” of the message. Then, an optional transform may be applied to mHash to generate a further encoded message EM. Alternatively, the hash digest can be directly used as EM. Next, a signature for the message is generated by raising EM to the power d modulo n, equivalent to applying the RSA decryption method to EM using secret key k_{d}. This signature is appended to message M, along with the public encryption key, kₑ, to be used to recover EM from the signature. A recipient of the message can verify the message by first generating mHash by applying the same one-way cryptographic hash function to the message M. The recipient next applies the RSA encryption method to the signature to generate a value EM′ or, as expressed in FIG. 2:

EM′=signature^{e}(mod n)=ENC(signature,kₑ).

Next, in the case that the optional transform was applied to generate the signature, a corresponding reverse transform is applied to EM′ to generate mHash′. When mHash′ is equal to mHash, the hash value initially generated by applying the one-way cryptographic hash function to message M, the signature is verified. Note that the signer of the message uses the signer's private key, while the message can be verified by anyone with access to the signer's corresponding public key. Verification proves that the text of a received message M is identical to the text in the original message M that was signed by a party possessing the secret key k_{d}.

A digitally signed message comprises three elements: message contents M, a signature, and a public key used to recover a hash digest from the signature that is compared to a hash digest computed for M in order to verify M by a recipient of the message. A digitally signed message is vulnerable to a type of man-in-the-middle attack referred to as an “intercept/resign” attack. The attacker first intercepts a transmitted message. The attacker then alters the contents of the message M to produce new, different message contents M* and uses the attacker's own private key to generate a new signature for the new message contents M*, appending the new signature and the attacker's public key to the new message contents M* to generate a fraudulent digitally signed message. The sender information associated with the fraudulent digitally signed message is not altered by the attacker, so that the fraudulent digitally signed message appears, to a recipient, to have been received from the original sender. The fraudulent digitally signed message is then accepted and deemed to be valid by an unsuspecting recipient, because the verification method, discussed above, generates an mHash and mHash′ that are equal to one another, despite the fact that the fraudulent digitally signed message includes altered message contents M*.

Finally, other types of encryption/decryption methods employ a single key for both encryption and decryption. These methods are referred to as “symmetric key” cryptosystems. In this case:

C→ENC(M,k)

M→DEC(C,k).

Symmetric-key encryption uses a single key k for both encryption and decryption. There are many different crypto systems for symmetric key encryption. One example is the Advanced Encryption Standard (“AES”). In general, symmetric-key encryption employs a series of deterministic operations for encryption that can be inverted for decryption. For symmetric-key encryption, the encryption key k is held in secret by both communicating parties since, once revealed, a message encrypted using the key k can be readily decrypted when k becomes known and when the particular symmetric-key-encryption method is also known.

Public-key certificates, including certificates that follow the X.509 ITU-T standard, are frequently used in secure communications for verifiably binding a public key to a name or identifier, such as a business entity name or a business or personal email address.

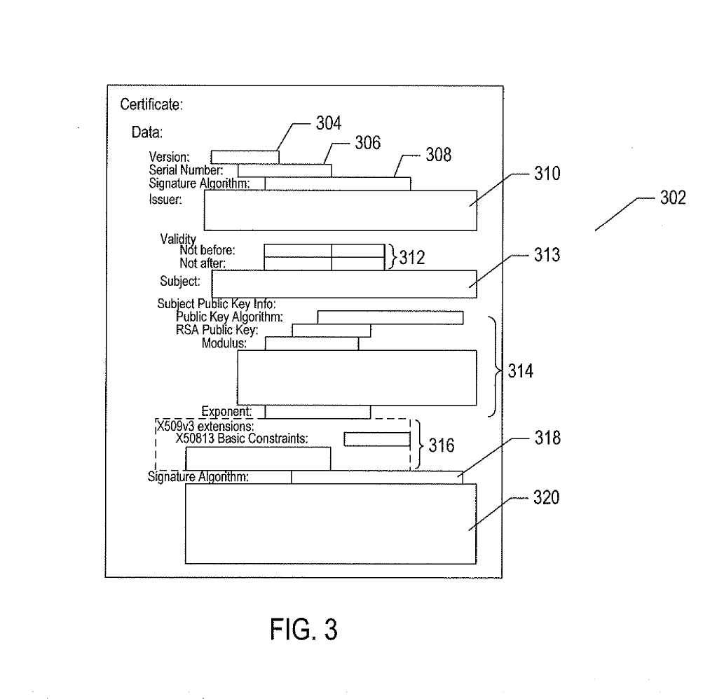

FIG. 3 illustrates the structure of an X.509 public-key certificate. The X.509 certificate 302 is essentially a data record that contains a sequence of standard fields that contain information needed to employ the certificate for verifying the binding, or association, of a user identifier or system identifier with a public key. These fields include a certificate version number 304, a serial number 306 that is unique with respect to a particular certificate authority that issues public-key certificates, an encoding of an identifier for the cryptographic method used to compute a signature over the certificate 308, information that identifies the issuer of the certificate 310, two date and time values 312 that indicate the beginning date and time at which the certificate becomes valid and the ending date and time at which the validity of the certificate ends, identifying information for the user or system that is bound by the certificate to a public key 313, a group of fields that indicate the cryptographic algorithm for which the public key is used and that include the public key 314, optional fields 316, referred to as extensions, that include additional information, an indication of the signature algorithm 318, and the signature, computed by the issuing entity over the remaining fields of the certificate 320. In some cases, the additional information section can contain indications of a security protocol to be used when establishing a secure connection.

In general, public-key certificates are issued by trusted computer systems within entrusted organizations known as “Certificate Authorities” (“CAs”). CAs are well-known certificate-issuing organizations that issue public/private key pairs, including corresponding public-key certificates, as a commercial service. These organizations employ various due-diligence information-gathering techniques to verify the identity of a requesting entity prior to issuing a key pair and public-key certificate. Large organizations, such as universities or big companies, may perform the function of a CA in order to generate public-key certificates for their use, referred to as “self-signing.”

A public-key certificate is transmitted, by a first entity possessing the public-key certificate and the corresponding private key, to other entities in order to enable the other entities to securely transmit information to the first entity and to enable the first entity to digitally sign information that can then be verified by use of the public key by the other entities. For email, a sender transmits the sender's public key to other entities by signing emails transmitted to the other entities. The public key component of the digital signature can be saved for further use by those who receive the emails. Public-key distribution by this method generally involves public-key management, including procedures for public-key revocation, expiration, and replacement. Public-key management may be a burdensome overhead, often resulting in complexity that hinders use of encryption for communications.

### Potential Security Breaches Despite the Use of Protocols Employ Public/Private and Symmetric Key-based Cryptography

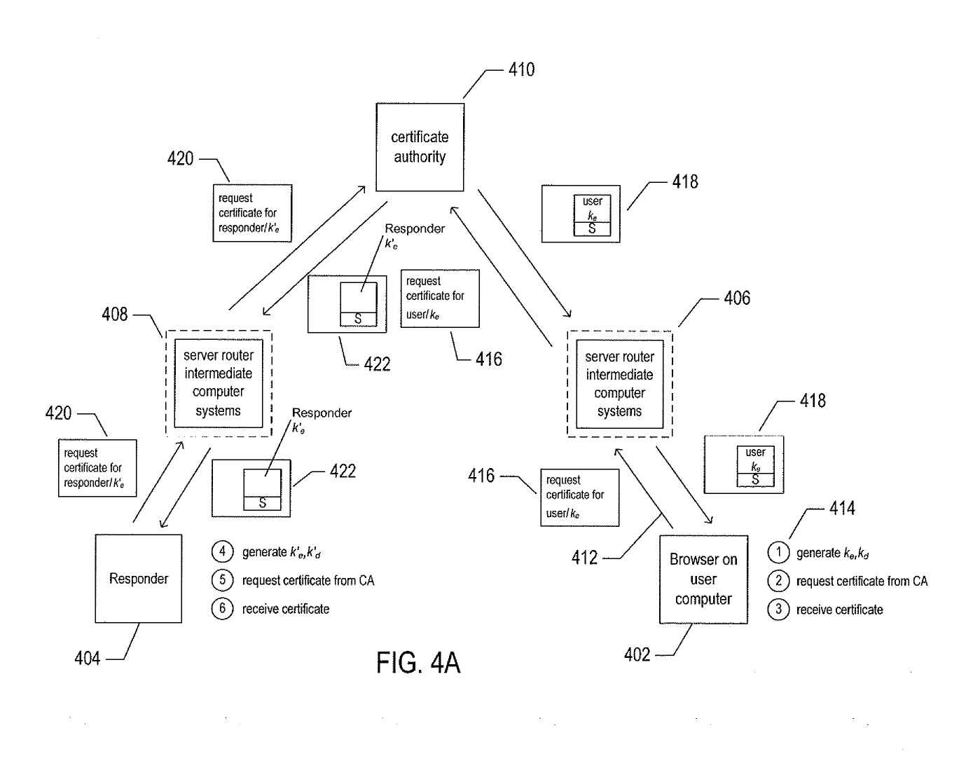

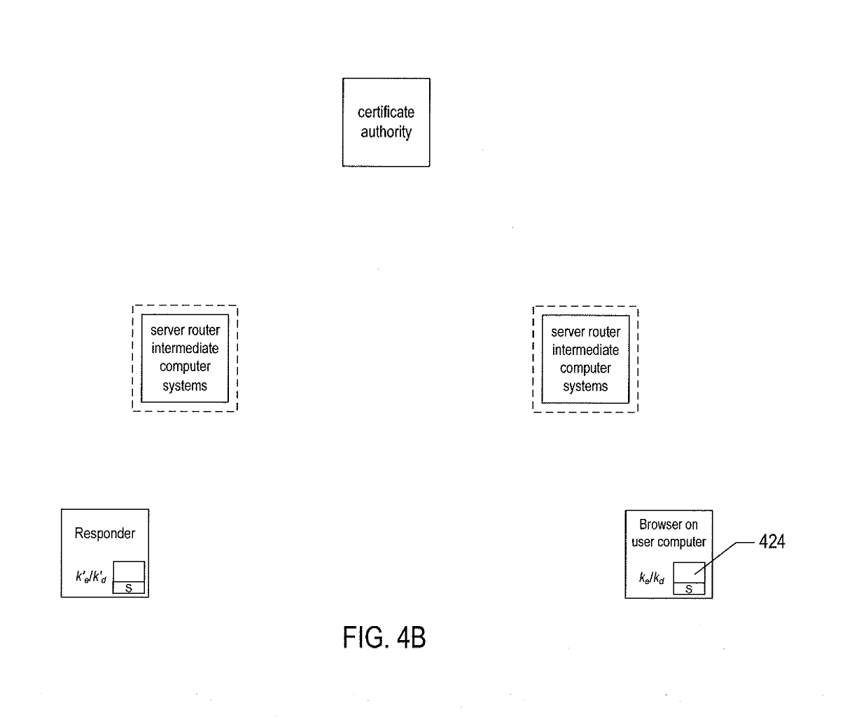

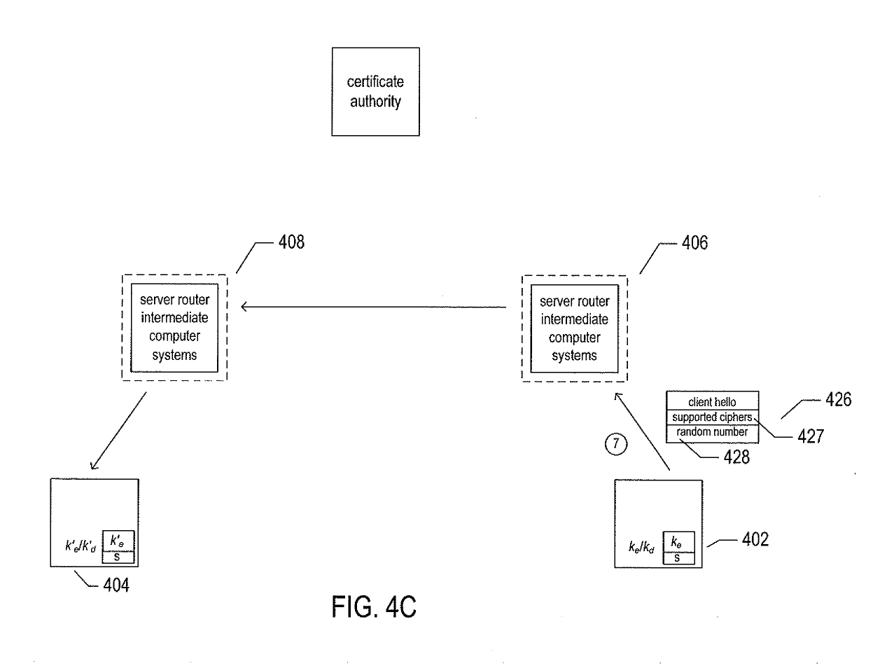

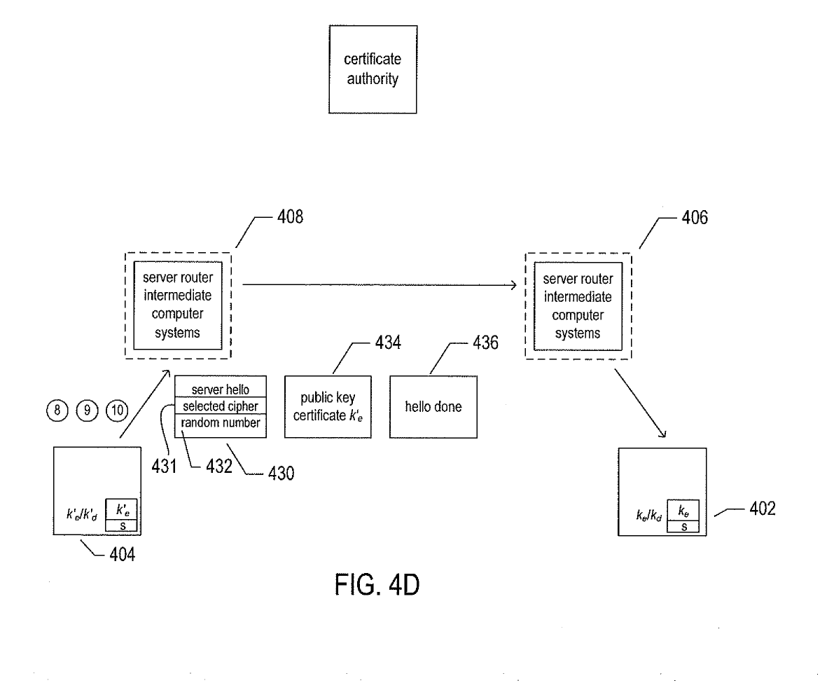

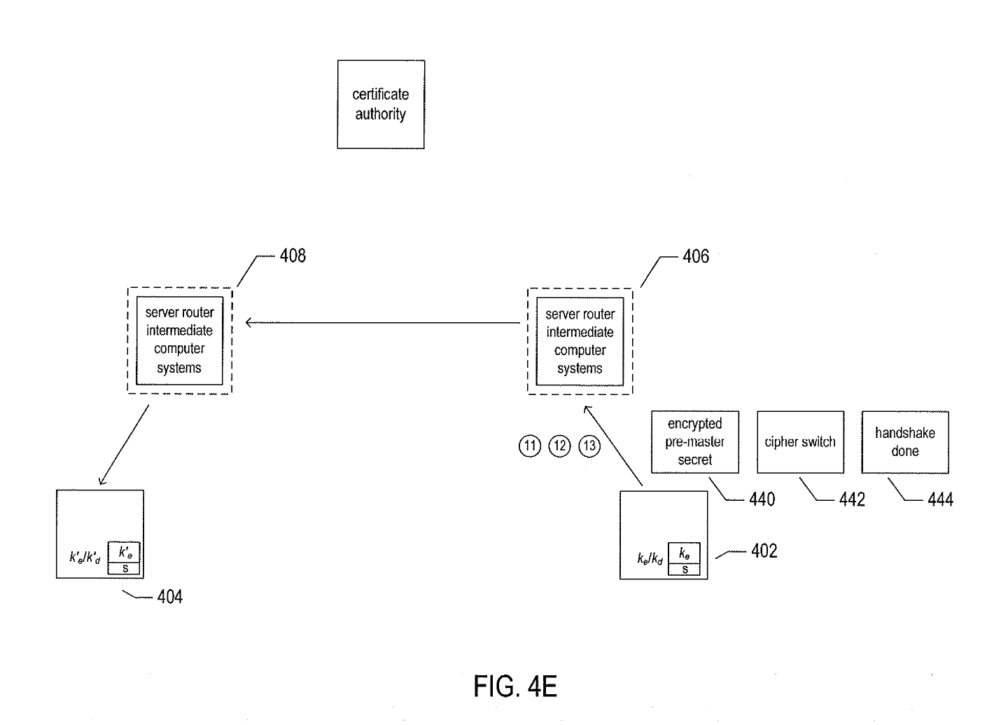

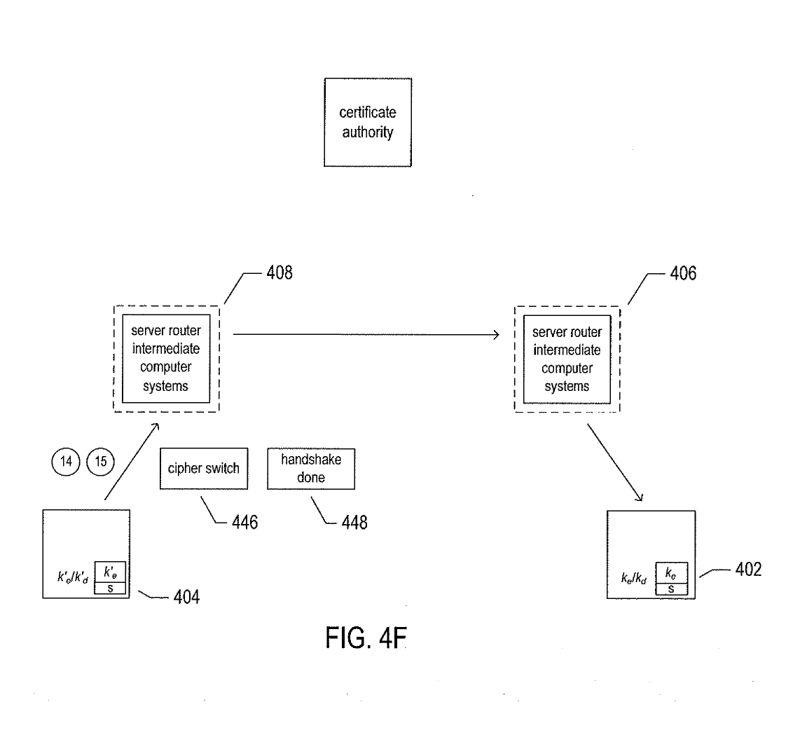

FIGS. 4A-F illustrate a basic, public/private-key-based secure information exchange between a user and a remote responder. FIGS. 4A-F all use the same illustration conventions, next described with reference to FIG. 4A. The various computer systems are represented in FIGS. 4A-F by rectangles, such as rectangle 402 representing a user computer, rectangle 404 representing a responder computer, rectangle 406 representing one or more intermediate computers that interconnect the user computer to remote computers via the Internet or another public network, rectangle 408 that represents intermediate computers that interconnect the responder computer 404 with the Internet or another public network, and one or more computer systems 410 within an organization that serves as a certificate authority. Arrows, such as arrow 412, indicate transmission of information as one or more messages or packets from one computer to another, with certain of the arrows labeled with indications of the type of message being sent. Finally, the figures include numerically labeled indications of the steps involved in the information exchange, the numerical labels indicating the order of the steps in the sequence, such as circled numerical label “1” 414 indicating the first step in the process.

In a first step, the browser on the user's computer, in certain cases in response to certain user inputs, and, in other cases, in response to internal events, generates a new public/private key pair kₑ/k_{d} and then requests a public-key certificate from the certificate authority 410 via a request message 416. The request message is sent through various severs and routers 406 and intermediate routing systems within the public network to the certificate authority 410. In general, although not shown in FIG. 4A, the certificate authority would undertake information exchange with the browser on behalf of the user in order to obtain sufficient information to verify the user's identity and IP and email addresses. Upon verification, a certificate authority 410 returns a public-key certificate, such as the X.509 certificate discussed above with reference to FIG. 3, in a message 418 to the user. Similarly, the responder computer, in certain cases through a browser or application program, also generates a public/private key pair k′ₑ/k′_{d}, requests a certificate for the public key k′ₑ from the certificate authority in a request message 420 and, upon verification, receives a public-key certificate from a certificate authority in a response message 422. Note that the responder may use a different certificate authority than the certificate authority used by the user, or be a self-signer, although, in FIG. 4A, the same certificate authority 410 is shown as being used by both the user and responder.

Thus, as a result of the certificate requests and responses illustrated in FIG. 4A, both the user computer and responder computer have stored public/private keys as well as certificates for their respective public keys. FIG. 4B illustrates this state of the user computer and responder computer prior to initialization of an information exchange. In FIG. 4B, as in other figures of FIGS. 4A-F, the public-key certificates are represented by rectangles, such as rectangle 424, with the lower section labeled “S” representing the signature over the certificate generated by the certificate authority using the certificate authority's private key.

Next, as shown in FIG. 4C, the browser on the user computer, generally in response to user input, generates a request for initial information from the responder and transmits that request to the responder, shown as step 7. For establishing a secure-communication session, the initial request is referred to as a “client-hello” message and is a first step of a multi-step handshake carried out between a user, also referred to as the “client” or the “requestor,” and a responder, also referred to as the “server.” The client-hello message 426 includes indications 427 of the ciphers supported by the user's browser and a random number selected by the user's browser. The multi-step handshake establishes: (1) the cryptography methods used during the session; (2) particular cryptographic keys used during the session; and (3) mutual authentication. There are many protocols used for establishing secure communications. The current discussion assumes use of an SSL RSA handshake. The currently disclosed methods and systems may employ many other types of protocols used for establishing secure communications.

Next, as shown in FIG. 4D, the responder responds to receipt of the client-hello message by, in step 8, returning to the user a server-hello message 430 that includes an indication of a selected cipher 431 and a random number generated by the server 432. In step 9, the responder sends the responder's public-key certificate 434 to the user. In step 10, the responder sends a hello-done message 436 to the user. In certain protocols and implementations of protocols, multiple messages may be combined together in fewer transmitted messages.

Next, in step 11, as shown in FIG. 4E, the user, in response to receiving the server-hello message, public-key certificate, and hello-done messages from the responder, transmits an encrypted pre-master secret 440 to the responder, encrypting the pre-master secret using the responder's public key. The pre-master secret is generated as a function of the random numbers exchanged by the user and responder. Then, in step 12, the user transmits a cipher-switch message 442 to the responder. Finally, in step 13, the user transmits a handshake-done message 444 to the responder.

As shown in FIG. 4F, the responder responds to receipt of the encrypted pre-master secret, cipher-switch message, and handshake-done message by, in steps 14 and 15, returning to the user a cipher-switch message 446 and a handshake-done message 448. At this point, the user and responder can continue to exchange encrypted messages using the selected cipher and a symmetric encryption key generated from the pre-master secret.

After transmission of the encrypted pre-master secret by the user to the responder, in step 11 shown in FIG. 4E, the user and responder compute the symmetric session key that is used to encrypt transmissions following completion of the handshake, in both directions, for the remainder of the session. At this same point in the process, the user and responder also compute a key used to compute message authentication codes (“MACs”) for the handshake messages. Such MACs can then be compared for additional validation of the integrity of a completed handshake. A secure successful conclusion of the handshake protocol relies on: (1) correct and unaltered transmission of the random numbers in steps 7 and 8; (2) correct and unaltered transmission of the supported-cipher and cipher-selection information; and (3) successful authentication, by the user, of the responder's public-key certificate and determination, by the user, that the responder's public-key certificate is valid and unrevoked, which may involve access of a database of revoked certificates.

Protocol steps 7-10, shown in FIGS. 4C-D, involve transmission of clear-text, unencrypted messages, and thus present opportunities for man-in-the-middle attackers. Several strategies have emerged to deal with the possibilities of such attacks. The DNS Authentication of Named Entities (“DANE”) protocol employs DNSSEC and inserts, early in the protocol a step to derive a DNS domain name from the server identity domain name. The derivation involves prefixing the server identity domain name with underscores, a port number, and protocol name. For example, DANE generates, for the server identity domain name “server.example.com,” the derived DNS domain name “_{—}443_tcp.server.exmple.com.” The derived domain name is then used to retrieve, from a DNSSEC server, a new DNSSEC-authenticated TLS Association (“TLSA”) resource record. The TLSA resource record is associated with the server public-key certificate, and specifies steps that are employed to authenticate the public-key certificate by a user. When authenticated, the third above-mentioned reliance is satisfied. However, the first and second above-mentioned reliances may still be in doubt. In another approach, which may be used with or without DANE, both parties compute MACs for each message of the handshake. Additional protocol steps compare these values after the fact, or possibly incrementally. When the message MACs all agree, the integrity of the handshake is validated after it has completed.

A weakness of the above-described handshake protocol, and the above-mentioned steps to compensate for this weakness, is that strong cryptographic protections do not commence from the very first steps of the handshake protocol. The initial clear-text messages provide an entry point for attackers and eavesdroppers.

### Network Protocols, DNS, and DNSSEC

The architecture of network protocols, including those used in the Internet, is generally considered to include four layers of functionality, each higher-level layer building upon, and benefitting from, the underlying layers. Each of these layers provides functions that operate in concert to sustain the massive volumes of communication operations, carried out among millions of systems and users, that currently occur daily within the Internet. Each of these layers in an endpoint system provides capabilities for communicating with a corresponding peer layer in another endpoint system.

The lowest layer of the network-protocol architecture is referred to as the “link layer” or as the “network-interface layer.” The link layer is concerned with the hardware network interface adapters that connect a computer to the wired or wireless data transmission media over which network data flows at the physical level. Operating system I/O drivers that control the data input and output functions through these interface adapters function at the link level of the network architecture.

The second layer of the network-protocol architecture is referred to as the “network layer” or the “Internet Layer.” This layer handles the routing and movement of data packets among the stationary or mobile endpoint systems, often referred to as “hosts,” of the network. It is at this layer that communication endpoints are identified by assigning to each endpoint an Internet-protocol address (“IP address”). Identifying a target endpoint system by its assigned IP address enables data streams to be correctly directed by routers to specific endpoint systems. There are two basic types of IP addresses: IPv4 addresses and IPv6 addresses. IPv4 addresses are 32 bits in length. IPv6 addresses are 128 bits in length. As the Internet has evolved, and various blocks of IPv4 addresses have been assigned to various organizations and individual systems, the available supply of IPv4 addresses has been exhausted. Because IPv6 addresses are 128 bits in length, there are more than 3.4*10³⁸ unique IPv6 addresses, more than sufficient for the foreseeable future.

The third layer of the network-protocol architecture is referred to as the “transport” layer” and provides for the flow of data among applications in host systems. It is at this layer that the Transmission Control Protocol (“TCP”) and User Datagram Protocol (“UDP”) are found. TCP organizes data streams into chunks, referred to as “packets,” and ensure that transmission of packet sequences is reliable. The UDP protocol is a simpler protocol that sends individual data packets, referred to as “datagrams” from one endpoint to another. Reliability is generally implemented on top of the UDP protocol.

The fourth, and highest, layer of the network-protocol architecture is referred to as the “application layer.” This is the layer at which user applications in different hosts communicate with one another, each invoking underlying transport, network, and link functionality to do so. Standard network applications, as well as user applications, operate at this level in endpoint systems.

The concept of name servers, which, over time, grew into the DNS, was created in the mid 1970s to enable attributes, particularly IP addresses, of a named endpoint system to be maintained in a well-known location. It was determined that it was much easier for people to remember the names of endpoint systems, or of standard services provided in endpoint systems, than to attempt to memorize and specify the IP addresses and other low-level details about those systems. From this beginning, the DNS has evolved to become the world's largest public distributed database. DNS is worldwide, hierarchically organized, highly distributed, and highly redundant, providing the high levels of scalability and availability needed for a shared data base that is accessed in order to establish each of many billions of Internet connections each day.

As DNS evolved, IP addresses became named and looked-up by hierarchical connection endpoint names, referred to as “domain names,” that are far easier for people to use and remember than fixed-length-bit-string IP addresses. Domain names comprise a right-to-left hierarchical sequence of tokens of alphanumeric characters. The tokens are separated by periods, for IPv4 addresses, or colons, for IPv6 addresses. The entire domain name begins with an explicit or assumed rightmost period designating any DNS root server.

A typical domain name for a financial firm web server, for example, might be: “www.mybank.com.” This is a fully qualified domain name (“FQDN”), having an explicit rightmost period. Alternatively, a non-FQDN domain name, “www.mybank.com,” having an implied rightmost period, may be used for the financial firm web server. The rightmost token of a domain name is referred to as the top-level domain name (“TLD”). The TLD is the highest point under a root server in the domain hierarchy, and may be of several types: (1) generic (“gTLD”); (2) country-code (“ccTLD”), or (3) sponsored and limited registration (“sTLD”). The next token, to the left, is referred to as the second-level domain name (“SLD”). Tokens within a domain name are referred to as “subdomain names.” The leftmost domain name token name is referred to as the “host name” or “service name.”

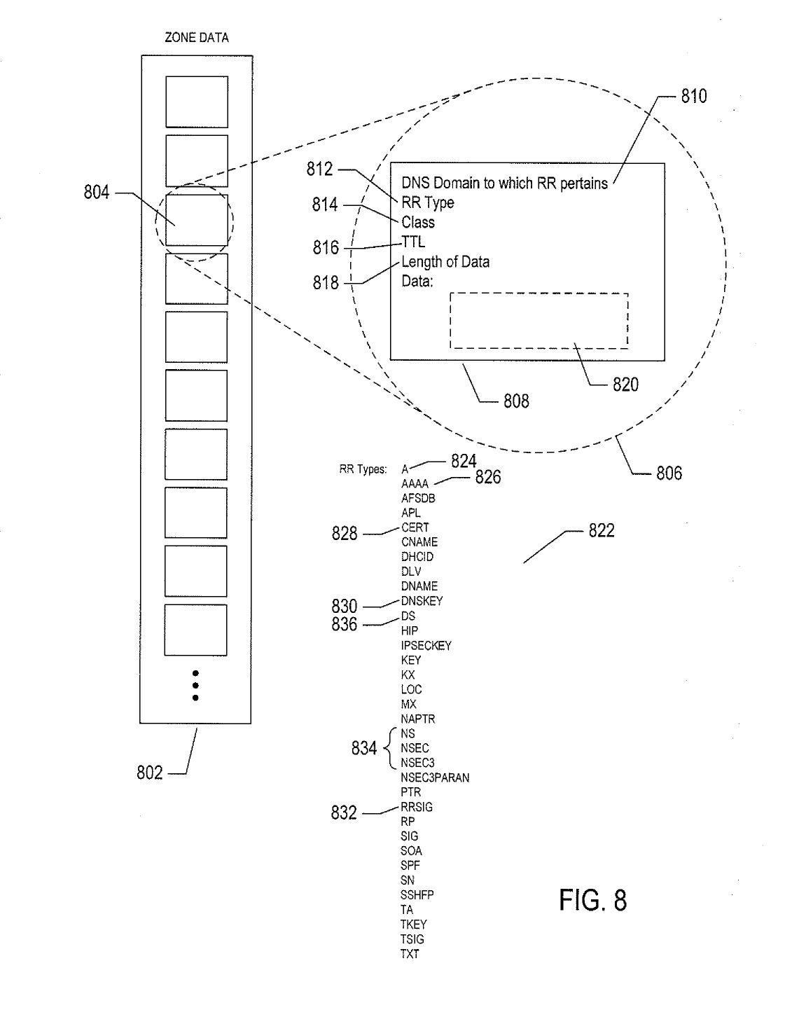

The entire DNS database is massive. No single DNS name server would be able to contain the entire DNS database. To provide the needed scalability and redundancy-based high availability of sufficiently many name servers, the DNS naming and content are organized as an extensible hierarchy, which enables authority over different parts of the DNS name space and content to be delegated to different name servers throughout the world. DNS database content consists of various types of resource records (“RRs”) each encoding a particular type of important information, as shown in FIG. 8. Related RRs are organized into larger groups, referred to as “zones.” Authority over each zone is delegated to a particular DNS name server, of a type referred to as an “authoritative server.” Authoritative name servers can contain multiple zones, sometimes very large numbers of zones. Often, zones correspond directly to domains. But subdomains also can be organized into separate zones.

Retrieving RRs from the DNS database is known as “name resolution.” For example, retrieving the IP address for the bank's endpoint web server, which provides the www.mybank.com web service, can be viewed as resolution of the “www.mybank.com.” domain name. Because the naming information in DNS is distributed throughout a hierarchy of DNS name servers, name resolution comprises two phases. The first-phase goal is to find the DNS name server that contains the RRs being sought. Once the IP address of the DNS name server containing the zones for the full domain name is found, a DNS request is used to retrieve the sought RRs.

There are two basic methods for DNS name resolution. The first is referred to as “iterative resolution” and the second is referred to as “recursive resolution.” Both methods involve stepping through the DNS hierarchy, as guided by the FQDN being resolved. For iterative resolution, the requestor initiates each of the steps through the hierarchy, analyzes the returned results, and determines the next step to be taken. The very last request retrieves the sought RRs. For recursive resolution, the DNS request is made to a type of DNS name server, referred to as a “caching server,” that performs the resolution steps and returns only the sought RRs.

In both methods, all but the last of the DNS requests are used to find the correct DNS name server for the last and final request. For either resolution method, every DNS step uses an FQDN argument. The first call is to a DNS root server. Endpoint systems contain a table of the DNS root server IP addresses. The DNS server referred to as a “root server” generally may not have the requested RRs, but does have at least two NS RRs containing the names of corresponding DNS name servers that are authoritative for the TLD. A second DNS request for an A RR, containing an IPv4 IP address for a returned authoritative TLD name server name, is then used to retrieve the DNS name server IP address for the next step. Another mechanism, referred to as “glue records,” is also provided to eliminate the need for a second request. The returned IP address is used for the next step. Each step effectively increases the length of the rightmost portion of the FQDN that has been resolved. This continues until the IP address of the DNS name server authoritative for the entire domain name is used to retrieve the sought RRs. At this point, the sought RRs are returned directly to the requestor, in the iterative-resolution case, or returned to the resolving DNS server that then conveys them to the requestor, in the recursive-resolution case.

Initially, as stated previously, DNS was deployed to look up IP addresses from domain names. It also was used to look up domain names from IP addresses. As DNS evolved, many new types of content were introduced. DNS content is encoded as RRs grouped systematically into zone files. Multiple RRs with the same name, class, and type, within a zone file are referred to as “RRsets.” The formats of zone files and their RRs are standardized to ensure portability.

Arguments supplied to system and software applications at the application level, such as browsers and mail servers, are often textual information concatenated with fully qualified domain names. An argument to a browser, for example, may prefix a protocol designation to the domain name of an intended web server. This results in browser arguments such as: http:://www.myfriend.org and https://www.mybank.com. Other arguments may be appended as parameters to a domain name, such as: get.adobe.com/flashplayer/. For mail servers, prepending the destination user's name and a “@” produces email addresses such as: john.smith@HP.com. Such arguments do not modify a DNS domain name, but surround it with other information needed by a particular software application.

One introduction of new content and capabilities to the DNS system is the DNSSEC, accompanied by the signing of the DNS root servers. DNSSEC introduced new RR content types, referred to as DNSKEY, RRSIG, DS, NSEC, NSEC3, NSEC3PARAM, and DNSKEY. These additions enable zone file data to be organized into RRsets that can each be digitally signed by an appropriate DNSKEY. This produces an RRSIG RR containing the digital signature that is returned with the corresponding RRset. The extension, using the DS RR, is also able to construct a signature chain of trust for each RRset, anchored by signed root servers. Signed RRsets can be delivered from DNSSEC servers, can be cryptographically validated using the corresponding DNSKEY RR, and can be trusted due to the cryptographic chain of trust established within the DNSSEC database. Specifically, pubic-key certificates that are published in DNSSEC name servers can be delivered from DNSSEC servers, can be cryptographically validated, and can be trusted due to the cryptographic chain of trust established within the DNSSEC database. Thus, the DNSSEC system has become a trustworthy worldwide, hierarchically organized, highly scalable, highly distributed, and highly redundant public database.

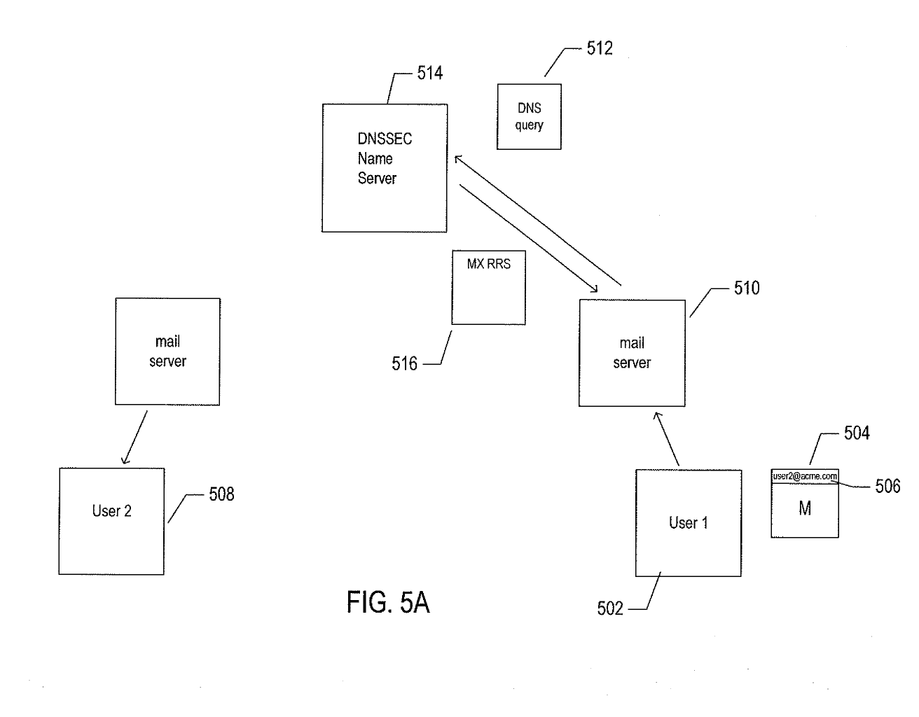

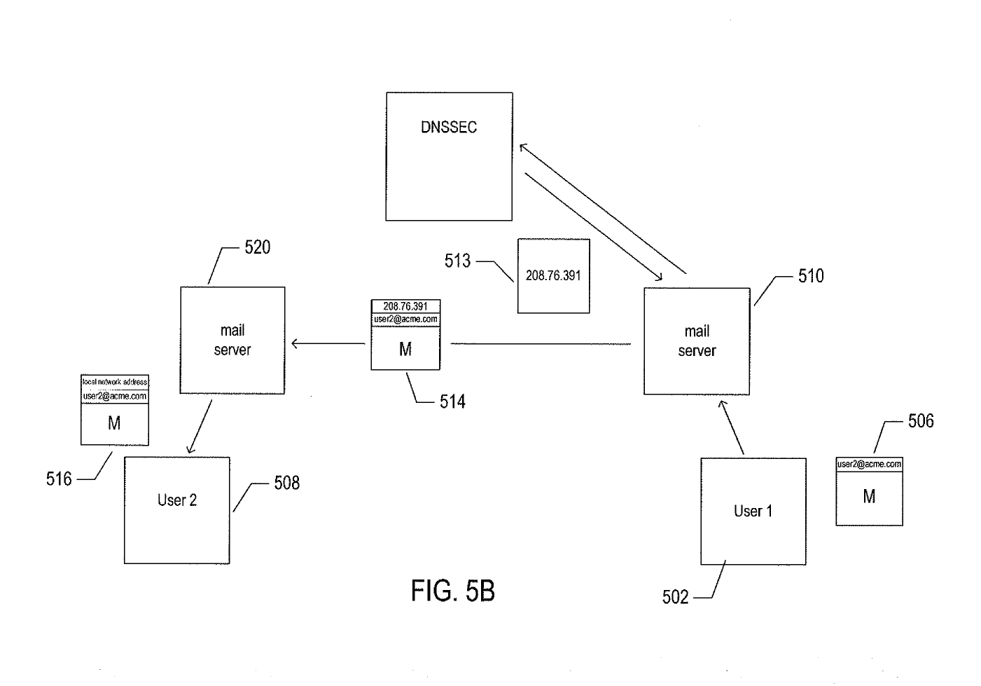

FIGS. 5A-B illustrates human-readable email-address resolution by the DNSSEC. Email addresses generally have the form “user.name@acme.com,” where the left-hand portion, prior to the symbol “@,” is the name of the user and the right-hand portion, following the symbol “@,” is a human-friendly name for the Internet domain in which the user's mail server physically resides. However, these human-friendly email addresses need to be translated into IP addresses which include groups of numbers separated by periods or colons. The IP addresses are digitally encoded with messages and packets for routing these messages and packets through local and public networks and communications systems to their intended destinations. DNSSEC manages a very large, globally distributed database and many DNSSEC name servers that together provide translations of the human-friendly alphanumeric email addresses to IP addresses of mail servers. Similarly, DNSSEC also can provide translations of portions of universal resource locators (“URLs”) to IP addresses.

In FIG. 5A, a first user 502 prepares the email message 504 including the email address 506 of the intended recipient 508 using the user's local mailer application, which sends the message to the user's mail server 510. The mail server then issues a DNS query 512 to the DNSSEC name server 510, and receives, in response, a prioritized list of MX RRs 516 containing the names of applicable acme.com domain mail servers. As shown in FIG. 5B, the mail server 510 then selects one of the returned acme.com mail server names and requests, from the DNSSEC name server, the IP address 513 of the chosen mail server. The DNS query will involve at least two separate retrievals from the DNSSEC name server. After obtaining the acme.com mail server IP address, the mail server 510 can establish a TCP/IP connection with mail server 520, over which the email message 514 is transmitted to mail server 520 using the post office protocol (“POP”) or Internet message access protocol (“IMAP”). The receiving mail server 520 then queues the message 516 for retrieval when the second user's 508 mailer session requests delivery of received messages from mail server 520.

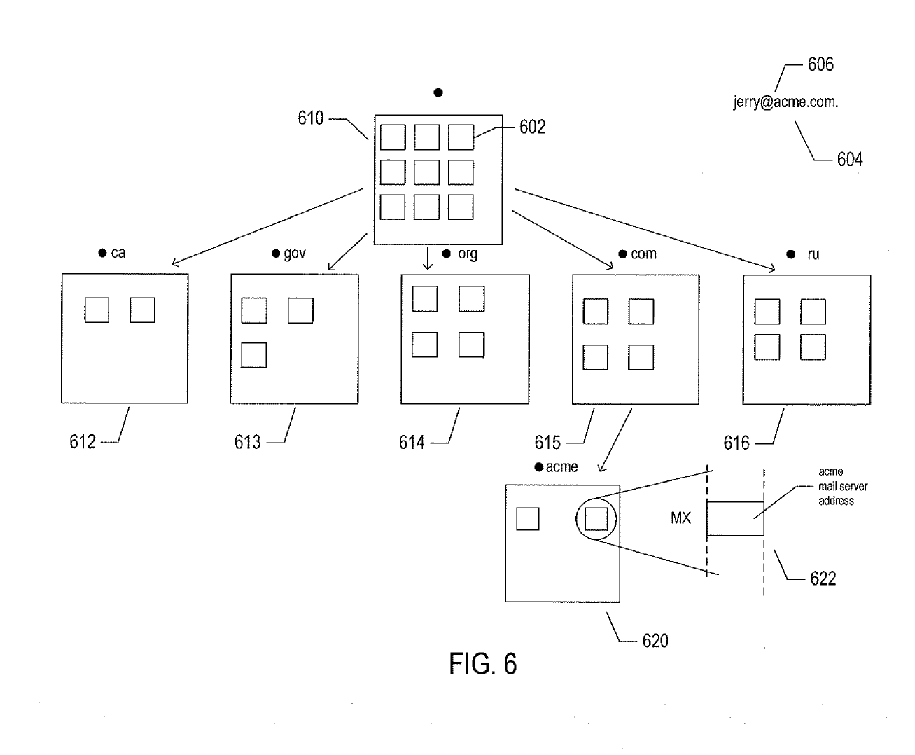

FIG. 6 illustrates the logical hierarchical organization of domains of DNS names and name servers. As shown in FIG. 6, individual computer systems are represented as small rectangles, such as small rectangle 602. One or more individual computer systems may together be considered to comprise a domain node in a hierarchical graph. These systems may be of various types, including endpoint hosts, mail servers, DNS name servers, and other types of systems. The name space of DNS is also hierarchical in nature. In FIG. 6, a simple email address 604 for a user named Jerry at the Acme Corporation is shown. To the right of the ampersand 606 is a domain name with an implicit rightmost period that represents the root domain. The TLD of this domain name is the gTLD “.com.” The SLD of this domain name is the acme company domain.

The root domain and hierarchically ordered subdomains of the name space, represented in FIG. 6 as large rectangles, constitute a tree-like hierarchical graph with nodes corresponding to domains and delegated domains. For example, in FIG. 6, node 610 corresponds to the root domain ‘V’, while the TLD domains “.ca,” “.gov,” “.org,” “.com,” and “.ru” correspond to second-level nodes 612-616. The SLD “.acme” domain corresponds to the third-level node 620. The hierarchical name space maps to DNS servers and other host computer systems in each domain. In FIG. 6, for example, the root domain maps to a large number of computer systems, including computer system 602.

The RRs for the various computer systems also may be hierarchically arranged into zones and subzones. In certain cases, there may be a one-to-one correspondence between name-space domains and zones, while, in other cases, a zone may maintain information for multiple subdomains. In FIG. 6, the domains map in one-to-one correspondence with zones. Each zone includes one or more computer systems that execute DNS functions for managing a portion of the DNS name space and for executing DNS queries. Each zone necessarily includes a master authoritative name server, and may additionally include slave authoritative name servers for redundancy, caching name servers, and other types of functionality.

As shown in FIG. 6, the master authoritative name server 620 within the DNSSEC zone for the “.acme” domain includes an MX RR resource record that contains the name of the acme mail server 622 and an A RR resource record that contains the IP address for acme mail server. Thus, a DNS query directed by mail server 510, in FIGS. 5A-B, to the DNSSEC name server ultimately involves access to an A RR containing the IP address of the acme mail server that is returned to mail server 510 in a response message.

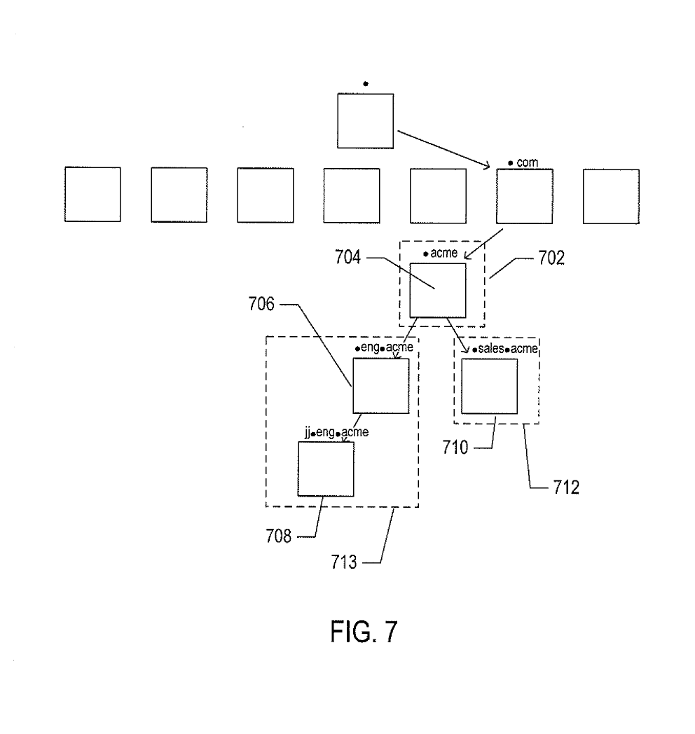

FIG. 7 illustrates additional subdomains of the “.acme” domain. As in FIG. 6, there may be a zone 702 corresponding to the SLD “.acme” domain 704. This zone may contain RRs for one or more computer systems executing DNSSEC functions. As shown in FIG. 7, the “.acme” subdomain may additionally include third-level subdomains “eng.acme” 706 and “sales.acme” 710, and a fourth-level subdomain “jj.eng.acme” 708. The first two of these three subdomains may be managed from zone files in subdomains 706 and 710, respectively, and the third of these subdomains may be managed from zone files in subdomain 710.

FIG. 8 illustrates the types of information stored within DNS name server zone files. The information within a zone is encoded and stored as resource records (RRs). In FIG. 8, the data stored and managed for a zone 802 can be drawn from a large number of RR types, such as RR 804, shown in greater detail in inset 806. An RR is a data record 808 that includes an indication of the DNSSEC domain to which the RR pertains 810, an indication of the RR type 812, an indication of the class to which the RR belongs 814, an indication of the amount of time that the record may be cached in a DNS caching server 816, an indication of the length of data included in the record 818, and the data contained within the record 820 appropriate to the particular RR type. In FIG. 8, a partial list 822 of RR types is provided. These record types include the types “A” 824 and “AAAA” 826 that store 32-bit and 128-bit IP addresses, respectively. In addition, other types include the type “CERT” 828 that stores a digital certificate, such as a public-key certificate, used internally within the DNSSEC system for various purposes, including secure communications. RR types further include the “DNSKEY” and “RRSIG” RR types 830 and 832 and the “DS” RR type 836. The RRSIG record type encodes the digital signature for a signed RRset, and is returned with the signed RRset in response to a DNSSEC request. The DNSKEY RR provides the public key needed to validate the digital signature returned in the RRSIG RR. The DNSKEY RR itself is not returned with the signed RRset, but is retrieved by a separate request to the DNSSEC name server. The DS RR is used to build the chain of trust based on digital signatures extending back to the root domain. Thus, a response to a DNSSEC query can be fully verified without having to rely upon a self-signed certificate-authority certificate or other such incompletely verifiable information. The RR types additionally include the “NSEC” RR type and the “NSEC3” RR type. The NSEC RR is returned when the requested RR does not exist. The NSEC3 RR is a feature later added to prevent DNSSEC zone-walking attacks that are possible only when NSEC RRs are available. The notation “NSEC*” is used designate either NSEC or NSEC3.

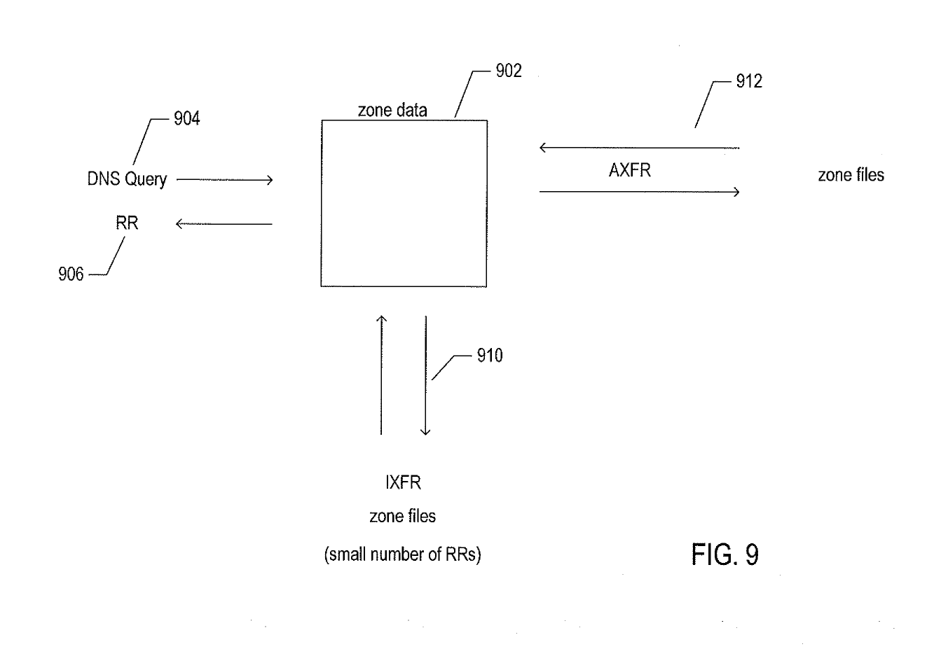

FIG. 9 illustrates data flow to and from zone data managed within DNSSEC name servers. In FIG. 9, the zone data is represented by rectangle 902, generally a large number of RRs pertaining to multiple computer systems. A DNS query issued to the DNSSEC name server 904 generally returns a particular RR 906 representing a response to the query. For example, a DNS query may need the IP address of a mail server for a particular domain. A first DNSSEC query is made for MX RRs, in response to which the DNSSEC returns a prioritized list of the names of the eligible mail servers. The name of one of these mail servers is selected, and a second request is made for the IP address corresponding to that name. The second request returns the IP address. It also is possible to transfer entire zone files from one DNS name server to another. The full-zone-transfer protocol is referred to as “AXFR,” and is often used when maintaining multiple copies of heavily used authority DNS name servers to scale DNS name server capacity and to provide availability. There also is a protocol for moving smaller groups of RRs in and out of zones. This incremental-zone-transfer protocol is referred to as “IXFR.”

### Methods and Systems to Which the Current Document is Directed

Returning briefly to FIGS. 4A-F, had both the user and responder published their public keys in DNSSEC, they each could first derived DNS domain names for the other's public-key certificate and requested the other's authenticated public-key certificate from DNSSEC. This would enable all outgoing messages to be encrypted by the sender and decrypted by the private key of the receiver. It also would enable validation of a partial digital signature on each incoming message. Thus, from the very start of the handshake, the messages exchanged between the user and responder would be strongly encrypted. Steps 9 and 10, shown in FIG. 4D, step 13, shown in FIG. 4E, and step 15, shown in FIG. 4F, would not be needed, nor would the MAC computations and comparisons be needed.

For various reasons, a public-key certificate may be revoked when, for example, it expires, it is replaced by a new public-key, or it appears that the security of the corresponding private key may have been compromised. Currently, revocation detection is handled by maintaining large databases of revoked certificates, against which any received certificate may be checked. However, this type of revocation checking is computationally inefficient and may suffer from maintenance losses, database failures, default system settings that do not mandate checking the database, and other deficiencies.

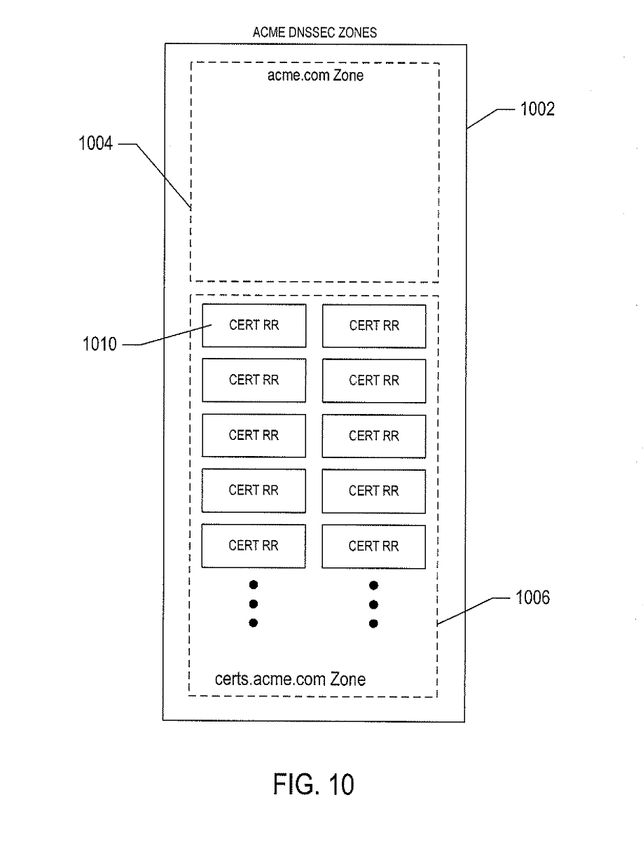

FIG. 10 illustrates an extension of DNSSEC used in the currently disclosed CDMS. FIG. 10 continues the description of the “.acme” domain name-space discussed above with reference to FIGS. 6 and 7. An organization, such as the Acme Corporation, which manages the “.acme” domain name-space on behalf of the entire Corporation, as well as other organizations that employ the currently disclosed CDMS, such as Internet service providers, each creates and manages a new subdomain and corresponding subzone to contain published public-key certificates, stored in CERT RRs, for users and other entities within the Acme organization.

In FIG. 10, the DNSSEC node corresponding to the “.acme” domain 1002 is shown to include a corresponding zone for the “.acme.com” domain 1004 as well as a new subzone 1006 corresponding to the new subdomain “certs.acme.com” of the “acme.com” domain. The “certs” subdomain of a given domain thus serves as a repository for published public-key certificates for entities within the parent domain of the “certs” subdomain. Public-key certificates, encoded in CERT RRs within the DNSSEC name servers with authority for the subzone containing the new “certs” subdomain CERT RRs are present when valid and absent before being created or after having been revoked or replaced.

Cryptographic/hash digests of an identifier of the entity to which the public-key certificate contained in the CERT RR is bound or of the entity that owns the public-key certificate may be used to name the CERT RRs within the certs subdomain. The DNSSEC servers may store and retrieve CERT RRs using these names rather than by using user names or other easily understood identifiers. Thus, merely guessing entity names and harvesting NSEC RRs cannot obtain information about the identities of entities within an organization. In one implementation of the CDMS, published public-key certificates are associated with email addresses of the entities to which they belong, and it is email addresses that are cryptographically hashed to produce digests by which corresponding public-key certificates can be retrieved from name servers by DNSSEC queries. Other naming conventions are possible.

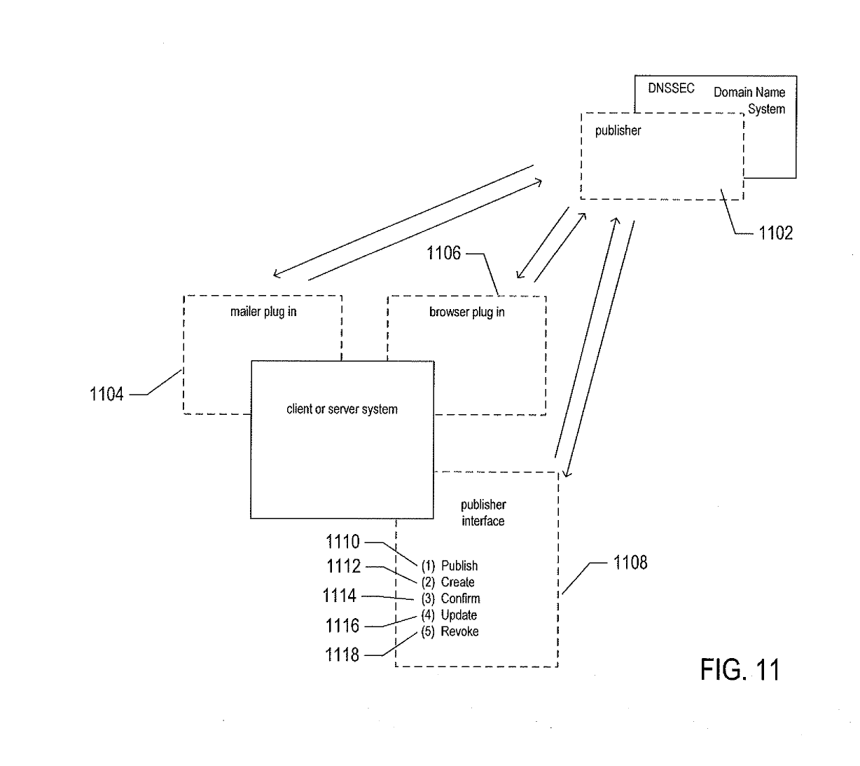

FIG. 11 illustrates additional components of the CDMS to which the current document is directed. The CDMS employs public-key certificates stored within the DNSSEC, as discussed above with reference to FIG. 10, as well as a new functional component referred to as the “publisher” component 1102. The publisher component implements the publisher side of CDMS protocols that allow public-key certificates to be published on behalf of client entities. The new publisher component may be implemented within an existing DNSSEC server, may be implemented in stand-alone hardware appliances interconnected with DNSSEC servers, or may be implemented in other types of systems that intercommunicate with client computers and DNSSEC. The client-side CDMS protocol can be implemented in one or more of mailer plug-ins 1104, browser plug-ins 1106, or new publisher-interface client-side applications 1108. The client-side component or components implement the client side of a publisher interface comprising the publisher-interface functions publish 1110, create 1112, confirm 1114, update 1116, and revoke 1118. Again, the publisher interface may be implemented by a mailer plug-in, browser plug-in, or new publisher-interface application, or a combination of these types of implementations. In addition, mailer plug-ins and browser plug-ins may implement additional functionality associated with the CDMS.

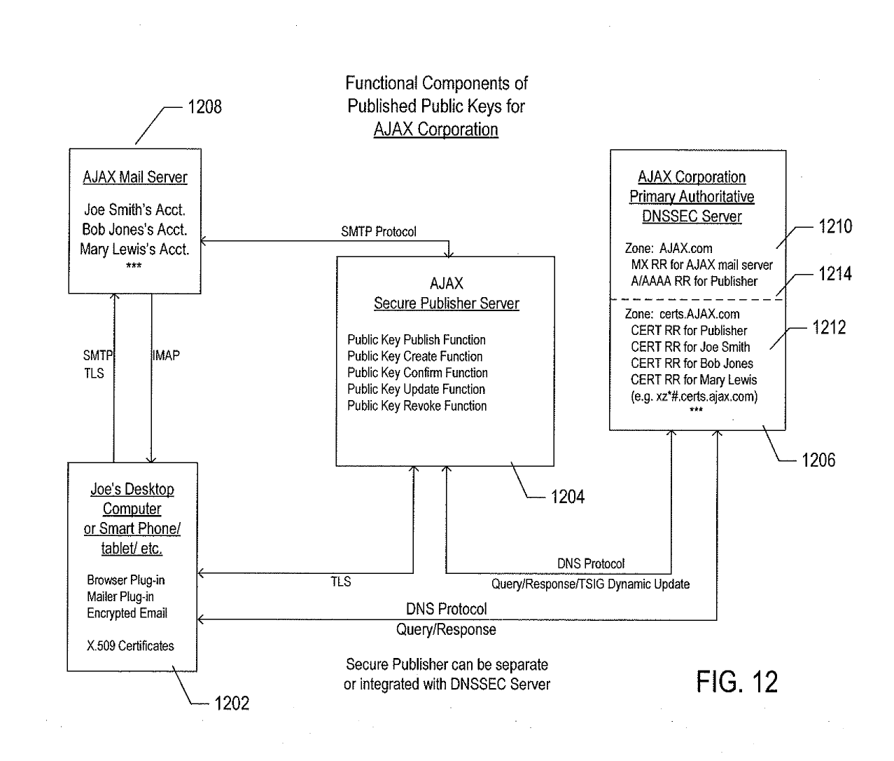

FIG. 12 shows components of the CDMS for a hypothetical Ajax Corporation. FIG. 12 shows the desktop computer for a user within the Ajax Corporation 1202, a publisher component 1204 of the CDMS locally managed by the Ajax Corporation, a primary authoritative DNSSEC name server for the Ajax Corporation locally managed by the Ajax Corporation 1206, and the mail server for the Ajax Corporation 1208. The primary authoritative DNSSEC server 1206 manages the ajax.com zone 1210 as well as the certs subdomain of the ajax.com domain 1212 in which published public-key certificates are stored. The publisher 1204 implements the publisher portion of the CDMS protocol while the client-side portion of the CDMS protocol is implemented in a browser plug-in and mailer plug-in within the user's desktop computer 1202. FIG. 12 shows the various underlying communications protocols that may be used for communication between the various components of the CDMS, including the simple message transfer protocol (“SMTP”), DNS protocol, and secure communications protocol TLS 1.1 or later versions of the TLS protocol. The dashed line 1214 in FIG. 12 indicates that, in many implementations, separate computer systems may be used to implement the authoritative DNSSEC server and certs subdomain that stores the published CERT RRs managed by the publisher.

Next, the publisher interface functions publish, create, confirm, update, and revoke are described. The function publish is invoked to publish a public-key certificate for a user or other entity. Publication results in installing the public-key certificate in the certs domain for an individual user or for another entity's use in the domain. It also enables external mail servers and other computational entities to access the published public-key certificate by generating a cryptographic-hash digest of an individual's or organization's identifier, generally an email address of the user or other entity, and using this digest in a request to the DNSSEC server containing the zone of published CERT RRs. A user furnishes an already generated public-key certificate to the publisher when invoking the publish function.

The create function is similar to the publish function, except that a new public/private key pair is generated by the publisher, a public-key certificate binding the newly created public key to the invoking user or entity is created and stored in the DNSSEC by the publisher, and an encrypted, newly generated private key is returned to the user. In other words, the create function also publishes a public-key certificate on behalf of a user or other entity and, in addition, creates the public key and a corresponding private key, prepares a public-key certificate on behalf of the user or entity, and returns the private key to the invoking user. The create function may also return a copy of the published certificate. In essence, the create function may seem to obviate the need for external CA or self-signer authorities. However, it should be recognized that the publisher offers, for the first time, a new tool and modes of operation of high utility for both CAs and self-signers. CAs, for example, may not only generate key pairs, but may also use the publisher to publish the new public keys in DNSSEC name servers. This allows CAs to sell reliable keys, provides CAs and CA customers with public key distribution without the burdens of distributing and protecting public-key certificates, and management of revocations and automatic renewals at expiration dates. A CA may, using the CDMS, may offer automatic revocation and roll-over of public keys at each expiration date.

The confirm function is used to confirm publication of a public-key certificate as well as the revocation status of the public-key certificate. Retrieving a public-key certificate from a DNSSEC name server can implement a portion of this function. When the public-key certificate is not obtained, the certificate has been revoked or expired. When the public-key certificate has been updated, the new certificate can be examined.

The update function is similar to the create function. However, the update function replaces any currently existing public-key certificate with a corresponding new public-key certificate, while the create function and publish function both fail in the case that a valid, non-revoked public-key certificate is already present within the DNSSEC name server for the named user or entity.

The revoke function removes a public-key certificate from the user or other entity's computer system and simply deletes the corresponding published public-key certificate from the publishing DNSSEC name server. In certain cases, the CDMS may support only a single public-key certificate for each user and other entities. In the more general case, the CDMS may support an arbitrary number of public-key certificates for users and entities, where each of the public-key certificates is associated with a role or type.

In one implementation of the CDMS, the CDMS computational components use standard DNSSEC queries to retrieve a DNSSEC published certificate. The DNS published-cert query can be issued to a DNSSEC name server by many computational entities, such as desktops, laptops, tablets, smart phones, host applications, software appliances, or mail servers, that currently access a DNSSEC name server using standard DNSSEC queries.

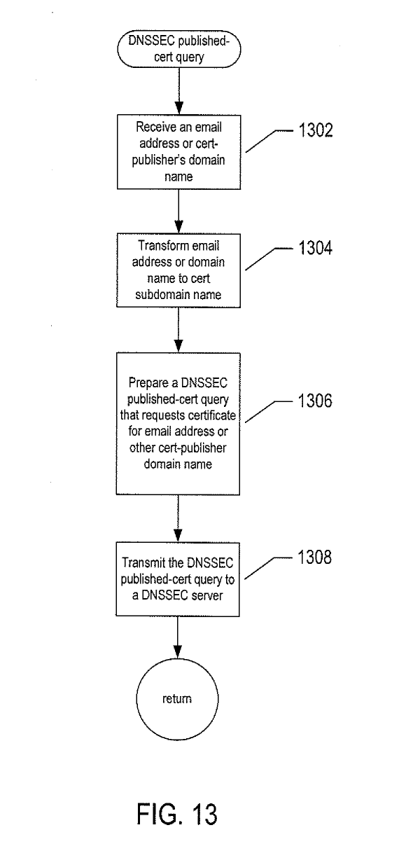

FIG. 13 illustrates, using a control-flow diagram, a DNSSEC published-cert query carried out by a mail server or other DNSSEC publisher to retrieve a public-key certificate. In step 1302, the querying entity receives an email address or the domain name of an entity that has published a public-key certificate and, in certain cases, a type or role indication that identifies the particular public-key certificate to be retrieved from the DNSSEC name server. In step 1304, the querying entity transforms the email address or domain name into a certificate subdomain name that may implicitly contain other encoded arguments. For example, an email address Joe@acme.com may be transformed to the “certs” subdomain name hash(Joe).certs.acme.com, or, for a different certificate type, to the “certs” subdomain name hash(Joe-R&D).certs.acme.com) for use at step 1306. These transformations are systematic and deterministic, so that a DNSSEC name server can process the subdomain name. However, any of many different possible transformations to differently formatted certificate subdomain names are possible for managing multiple types and classes of certificates. To systematically provide multiple types of certificates for the same party, such capabilities are also integrated into other system and application components of the CDMS. This ensures that the proper transformation is applied for any component processing the request prior to the DNSSEC name server retrieval. At step 1308 the querying entity transmits the transformed query to a DNSSEC name server.

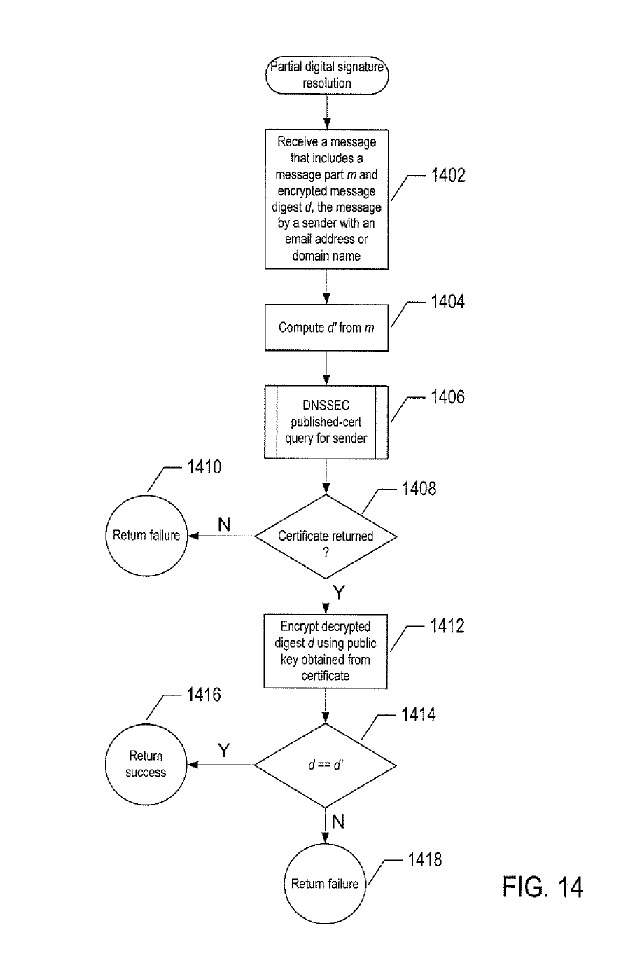

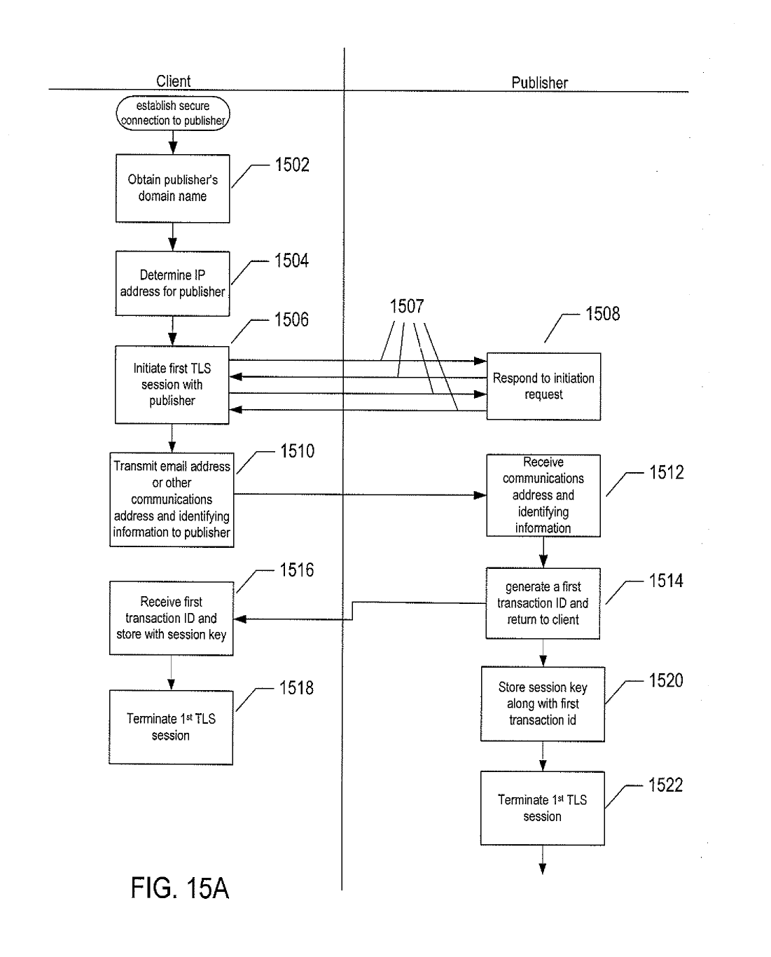

FIG. 14 illustrates implementation of partial digital signature resolution. Partial digital signatures are digital signatures that, unlike traditional digital signatures, do not include a public key for decryption of the encrypted digest. Instead, the recipient of a digitally signed message obtains the public-key certificate of the sender using a DNSSEC published-cert query. Because DNSSEC-provided public-key certificates are protected by the DNSSEC chain of trust, the recipient is certain that the public-key certificate obtained from DNSSEC for the sender is authentic. The recipient then uses the public encryption key within the public-key certificate to encrypt the decrypted message digest to determine whether or not the message contents are those originally used by the sender to generate the digital signature.

In step 1402, a digitally signed message M that includes a clear-text message m and a decrypted message digest d is received. In step 1404, the recipient computes a new digest d′ from m using a cryptographic hash function or other deterministic one-way function that is understood to generate digests. In certain cases, an identifier of the one-way function may also be included in the digital signature, when more than one one-way function can be used to generate digital signatures. In step 1406, a DNSSEC published-cert query routine, discussed above with reference to FIG. 13, is invoked to obtain the public-key certificate for the message sender, using the sender's email address or domain name. When no certificate is obtained, as determined in step 1408, failure is returned in step 1410. Otherwise, in step 1412, the public key is the obtained public-key certificate is used to encrypt the already decrypted digest d. When d′ is equal to d, as determined in step 1414, then success is returned in step 1416. Otherwise, failure is returned in step 1418.

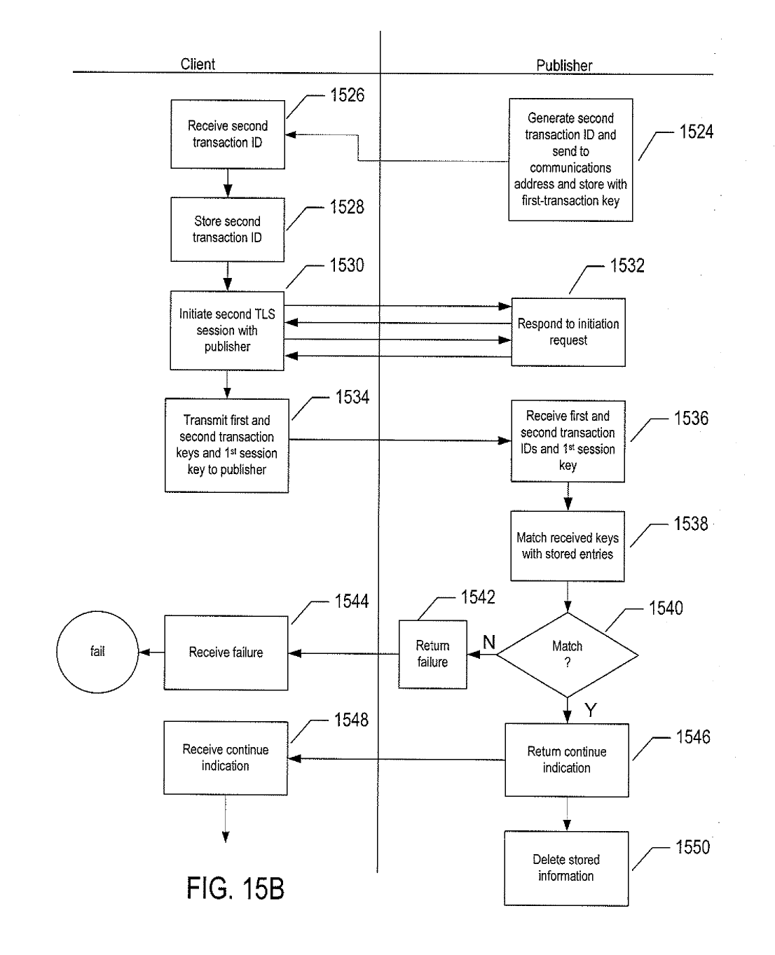

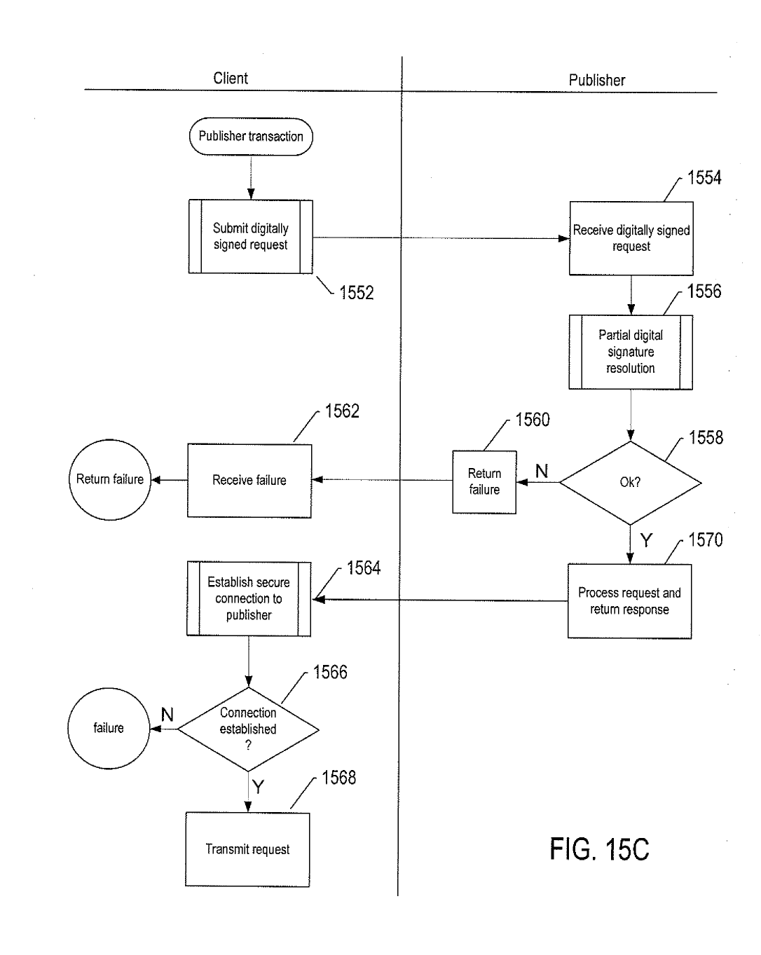

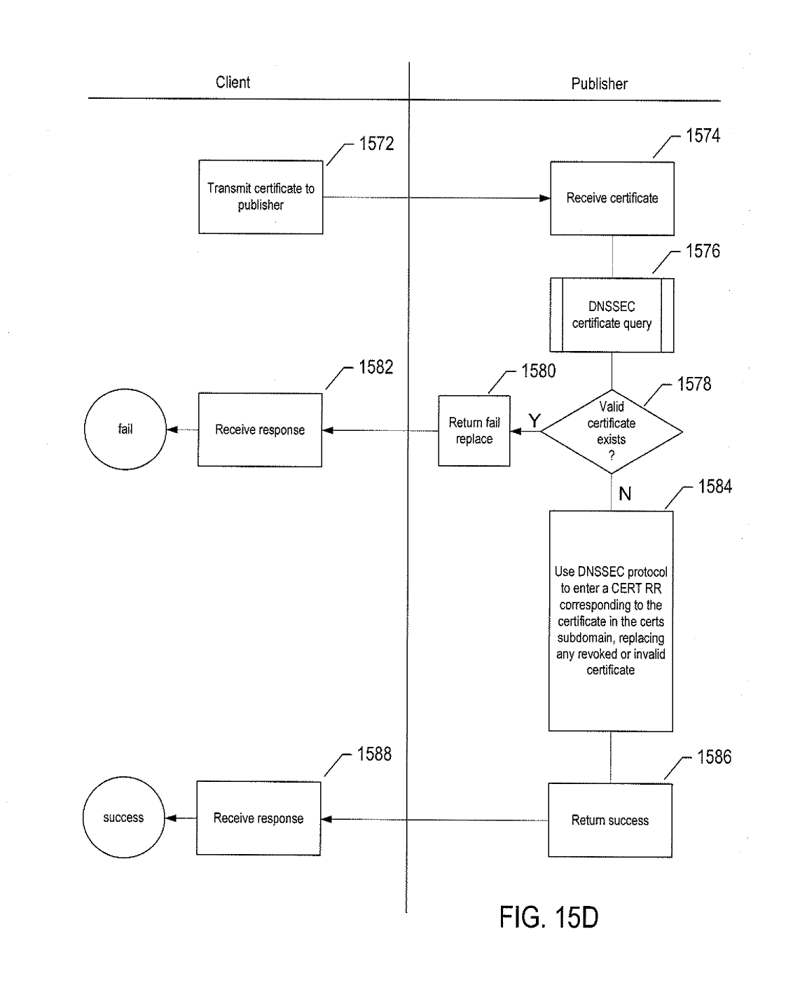

FIGS. 15A-D illustrate, using control-flow diagrams, implementation of the publisher interface functions. In each of FIGS. 15A-D, client actions are shown in the left-hand portion of the figures and publisher actions are shown in the right-hand portion of the figure. FIGS. 15A-B illustrate a first implementation of a method to establish a secure connection to the publisher by a client, in which the identity of each party can be authenticated by the other. The term “client” refers to a user of a client computer system, as well as a web browser or another application executing on a client computer, or an operating-system routine or control program executing on any of many different types of devices and systems. In step 1502, the client obtains the publisher's domain name and, in step 1504, retrieves the IP address and published public key of the publisher from a DNSSEC name server. In step 1506, the client initiates a first TLS session with the publisher, using the IP address and publisher public key obtained in step 1504. The publisher proceeds with a TLS handshake in response to the client request, as indicated by multiple interactions 1507 between the client and publisher. The establishment of this TLS session results in both the client and the publisher possessing a session symmetric encryption key, used to encrypt and decrypt information transferred between the client and publisher for the remainder of the session.

This protocol ensures mutual authentication of client and server. In an alternative implementation, signed messages between the parties may be employed. In step 1510, following establishment of the first TLS session, the client transmits the client's email address or other communications address and a well-known form of additional client-identifying information to the publisher, which receives the email address or other communications address and client-identifying information in step 1512. In step 1514, the publisher generates a first unique transaction ID, using the client-identifying information, and returns the first transaction ID to the client. In step 1516, the client receives the first transaction ID and stores the first transaction ID along with the first-session symmetric encryption key, and then, in step 1518, terminates the TLS session. Similarly, in step 1520, the publisher stores the first-session symmetric encryption key along with the first transaction ID and then, in step 1518, terminates the TLS session.

Turning to FIG. 15B, in step 1524, the publisher generates a second transaction ID and sends the second transaction ID to the client using the communications address received from the client in step 1512. Note that this transmission is carried out using a different type of communication, and is used to verify that the client is reachable through the communications address he/she supplied in step 1510. In step 1526, the client receives the second transaction ID and stores the second transaction ID in step 1528. Then, in steps 1530 and 1532, a second TLS session is initiated. In step 1534, the client replies and transmits the first and second transaction IDs, and the first-session symmetric encryption key, to the publisher encrypted by the second TLS session key. In step 1536, the publisher receives the first and second transaction IDs and first-session symmetric encryption key from the client and, in step 1538, attempts to match the first and second transaction IDs and first-session symmetric encryption key, received from the client during the second TLS session, with the previously stored the first and second transaction IDs and first-session symmetric encryption key. When a matching triple of first and second transaction IDs and first-session symmetric encryption key is not found in memory, as determined in step 1540, failure is returned, in step 1542, by the publisher to the client, which receives the failure in step 1544 and returns a failure indication as the return value of the publisher interface function. Otherwise, in step 1546, the publisher returns an indication that the publisher interface function can proceed, and, in step 1550, deletes the stored triple of the first and second transaction IDs and the first-session symmetric encryption key. In step 1548, the client receives the indication that the publisher interface function can proceed, and sends information defining the publisher-interface-function request to the publisher. The remaining steps are not shown in FIGS. 15A-B.

FIG. 15C illustrates a generalized publisher-interface-function implementation. This implementation assumes that the client's public key is available to the publisher. In step 1552, the client submits a partially digitally signed publisher-interface-function request to the publisher in the continuing TLS session. In step 1554, the publisher receives the partially digitally signed publisher-interface-function request and, in step 1556, employs the partial digital signature resolution method discussed with reference to FIG. 14 to determine whether the digitally signed publisher-interface-function request is valid. If the publisher-interface-function request is not valid, as determined in step 1558, then the publisher returns a failure, in step 1560, which is received by the client in step 1562. At this point the TLS session is terminated, and the client then attempts to use the method discussed with reference to FIGS. 15A-B, in step 1564. When a secure connection is once again established, as determined in step 1566, then the publisher-interface-function request is transmitted to the publisher, in step 1568. The publisher, in step 1570, processes the publisher-interface-function request, whether received through the initial partially digitally signed request or through the secure connection established by the method described with reference to FIGS. 15A-B. When a secure connection cannot be established, as determined in step 1566, failure is returned.

FIG. 15D illustrates implementation of the publish publisher-interface function. In FIG. 15D, it is assumed that either the publish request is transmitted with a resolvable partial digital signature or through an established secure connection. In step 1572, a certificate is transmitted to the publisher. In step 1574, the certificate is received by the publisher. In step 1576, the publisher uses the certificate to prepare a DNSSEC published-cert query and transmits the published-cert query to the DNSSEC name server. When the DNSSEC name server returns a CERT RR containing a valid and unrevoked public-key certificate, as determined in step 1578, then an error is returned, in step 1580, to the client which propagates back to the user or a user-invoked plug-in or application. Otherwise, in step 1584, the publisher uses the IXFR protocol or another means to transfer a CERT RR constructed by the publisher to contain the received public-key certificate to the DNSSEC name server to be installed into the authoritative zone for target certs subdomain. The CERT RR furnished by the publisher replaces any revoked or invalid certificate currently stored in the target certs subzone. Thus, as a result of execution of step 1584, the published-key certificate received in step 1574 is now installed into the DNSSEC name server, and is effectively published. An indication of a successful completion is returned, in step 1586, to the client, which then propagates the successful completion in step 1586 to the user or a user plug-in or application at step 1588.

The remaining publisher-interface functions are analogously implemented. For example, the create publisher-interface function involves transmission of information needed to construct a certificate from the client to the publisher, construction of a certificate by the publisher, rather than transmission of a certificate by the client, as in FIG. 15D. Upon successful publishing of the new certificate, the certificate is returned to the client along with the user's newly generated private key.

To implement the confirm publisher-interface function, the publisher formulates and issues a request for retrieving the identified certificate from the appropriate DNSSEC name server. This request returns the signed RRset containing the requested certificate, along with the RRSIG RR containing the digital signature of the RRset. A second request is formulated to retrieve the DNSKEY containing the zone-signing key for the zone from which the CERT RRset was returned. This key can then be used to validate the CERT RRset and its RRset digital signature previously returned in the RRSIG RR. As explained above, the DNSSEC system signatures are supported by a cryptographic chain of trust extending all the way back to a DNSSEC root domain name server.

The update publisher function is implemented similarly to the create publisher function, with the difference that the update publisher function first deletes, on the client side, any public-key certificate currently stored within the client's system, and also deletes on the DNSSEC name server side the public-key certificate that is to be updated. It then proceeds with the create publisher functions. As mentioned above, the revoke publisher-interface function also deletes the currently stored public-key certificate on the client side within the user's system, as well as the CERT RR containing the public-key certificate in the DNSSEC name server.

For both update and revoke, the publisher function protocol can first validate the IP address of the user's email server and the user's email account before undertaking the certificate update and revoke operations. The update and revoke may be directed to a single public-key certificate associated with a user, in CDMS implementations, and also may be directed to a public-key certificate having a particular specified role or type for its owner.

The CDMS securely publishes public-key certificates for a wide variety of different types of users and entities. These published public-key certificates become available to any computing system, such as a mail server, that can accesses DNSSEC name servers through DNSSEC queries. As a result, the published public-keys can be used as the basis for a wide variety of different types of secure communications, secure transactions, or digitally encoded information verification via digital signatures. For example, a mailer plug-in can retrieve the public-key certificate for the addressee of an email that is being sent and, when receiving a valid and unrevoked public-key certificate corresponding to the addressee, can encrypt the email using the addressee's published public key prior to transmission. Thus, a message sender need not have first received a public-key certificate from an addressee, and can verify association of the public-key certificate to the addressee through DNSSEC, rather than relying on external certificate authorities or other means. Published public-key certificates also can be used for validation of distributed software, for automated SPAM and Phishing-email-detection, discussed earlier, and for implementing a variety of different extremely secure transaction protocols that strongly authenticate multiple parties participating in the transaction.

To prevent intercept/resign attacks, certain implementations of the CDMS employ and utilize partial digital signatures, as discussed above. A partial digital signature comprises only the first two of the above-discussed three elements of a digital signature. The third element of a digital signature, the public key, is separately retrieved from a DNSSEC server, having been requested using a defined convention for deriving a sender's DNS certificate domain name from the identifier of the original sender. This permits retrieving a public key belonging to a particular named sender or organization and ensures that such a key has been authenticated by the DNSSEC cryptographic chain of trust anchored in a DNS root server. As a result, such a digital signature can be validated if and only if the actual signing party possesses the private key corresponding to the sender's public key retrieved from the DNSSEC server. As long as the sender retains sole custody of the sender's private key, man-in-the-middle intercept/resign attacks are prevented.

Such use of partial digital signatures, for example, is helpful for authenticating and verifying identities of email senders. Adopting a practice that all unsigned emails are discarded and that all signed emails are validated by partial signature methods, phishing and SPAM emails cannot fake or hide the true identities of their senders. Emails with invalid sender identities are automatically discarded by a mailer or can be identified and further analyzed to determine the actual sender. Thus, systematic deployment of DNSSEC public key publication can greatly reduce the likelihood of successful cyber attacks based on phishing, and can lead to ignoring and/or identifying SPAM purveyors.

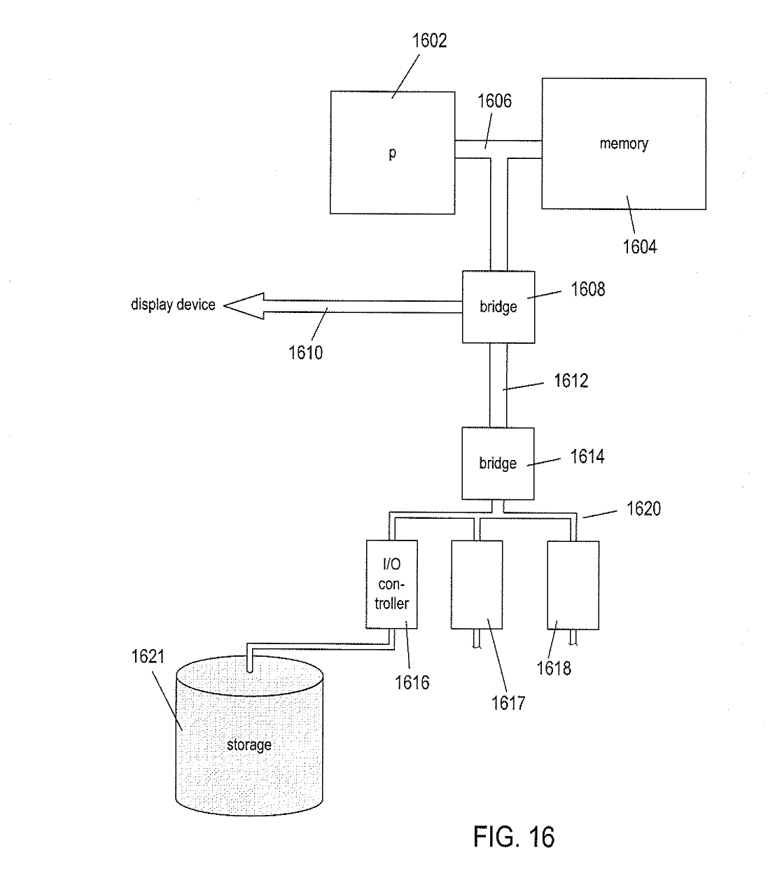

FIG. 16 provides a block diagram of a generalized computer system on which components of the certificate distribution and management system are implemented. The computer includes a processor 1602, memory 1604, a memory/processor bus 1606 that interconnects the processor, memory, and a bridge 1608. The bridge interconnects the processor/memory bus 1606 with a high-speed data-input bus 1610 and an internal bus 1612 that connects the first bridge 1608 with a second bridge 1614. The second bridge is, in turn, connected to various devices 1616-1618 via high-speed communications media 1620. One of these devices is an I/O controller 1616 that controls data exchange with a mass-storage device 1621. A software program that implements a video codec may be executed by the computer system to control video coding by the computer system. In this example, the software program is stored on the mass-storage device 1620 and paged, on an as-needed basis, into memory 1604. Instructions of the software program are fetched, by the processor 1602, from memory for execution. The phrase “electronic memory” refers to any of numerous data-storage components, including system memory, caches, mass-storage devices, and other such components that store computer instructions and program data for subsequent access.

Although the present invention has been described in terms of particular embodiments, it is not intended that the invention be limited to these embodiments. Modifications within the spirit of the invention will be apparent to those skilled in the art. For example, the publisher functionality can be distributed among client-side and publisher-side portions in a variety of different ways. The publisher interface may include additional functions or variations on the publisher functions addressed above. Variations may include different, additional, or fewer arguments in different implementations. As discussed above, the publisher functionality may be embodied in special-purpose hardware devices or in software implementations included in DNS servers or other systems. A variety of different hardware platforms may be used for implementing the publisher functions, and publisher routines can be implemented in many different ways by varying any of the many different design and implementation parameters, including control structures, modular organization, data structures, programming language, and other such parameters. While email addresses are an attractive option for identifiers bound to public keys by published-key certificates, other types of identifiers, such as corporate functional server or service domain names, may alternatively be used.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. Although not articulated in this application, benefits of the invention accrue to the operational practices of CAs, as well system and application developers. Such benefits are intended, and will become apparent to experts in each of these areas.

1. A public-key-certificate publishing system comprising:
a client-side publisher component, executed on one or more processors of a client computer system stored in an electronic memory within the client computer system, that, in response to a client-computer-system event, transmits a public-key-certificate-related request to a remote publisher service; and
the publisher service implemented as a hardware appliance or executed on a computer system, such as a DNSSEC server, that includes one or more processors and an electronic memory, the publisher service receiving the public-key-certificate-related request from the client-side publisher component, storing the public-key-certificate-related request in the electronic memory, and executing the public-key-certificate-related request by:
creating at least one DNSSEC request, and
transmitting the at least one DNSSEC request to a DNSSEC server for execution by the DNSSEC server.

2. The public-key-certificate publishing system of claim 1
wherein the public-key-certificate-related request is a publish request; and
wherein the publisher service extracts a public-key certificate contained in the publish request, creates a DNSSEC request that contains the extracted public-key certificate, and transmits the DNSSEC request to DNSSEC server to direct the DNSSEC server to store the public-key certificate into a certificate subdomain or forward the DNSSEC request to another DNSSEC server in order that the public-key certificate is stored in the certificate subdomain.

3. The public-key-certificate publishing system of claim 1
wherein the public-key-certificate-related request is a create request; and
wherein the publisher service extracts user information contained in the create request, generates a new public/private encryption key, creates a public-key certificate for the client-side publisher component, creates a DNSSEC request that contains the created public-key certificate, transmits the DNSSEC request to DNSSEC server to direct the DNSSEC server to store the public-key certificate into a certificate subdomain or forward the DNSSEC request to another DNSSEC server in order that the public-key certificate is stored in the certificate subdomain, and returns the generated private encryption key to the client-side publisher component.

4. The public-key-certificate publishing system of claim 1
wherein the public-key-certificate-related request is a confirm request; and
wherein the publisher service extracts public-key-certificate identifying information contained in the confirm request, creates a DNSSEC request that contains extracted public-key-certificate identifying information, transmits the DNSSEC request to DNSSEC server to direct the DNSSEC server to return the public-key certificate corresponding to the public-key-certificate identifying information or forward the DNSSEC request to another DNSSEC server in order that the public-key certificate is returned, and, when a valid and unrevoked public-key certificate is returned by a DNSSEC server in response to the transmitted DNSSEC request, returns, to the client-side publisher component, an indication that the identified public-key certificate is valid and unrevoked.

5. The public-key-certificate publishing system of claim 1
wherein the public-key-certificate-related request is an update request; and
wherein the publisher service extracts user information contained in the update request, generates a new public/private encryption key, creates a public-key certificate for the client-side publisher component, creates a DNSSEC request that contains the created public-key certificate, transmits the DNSSEC request to DNSSEC server to direct the DNSSEC server to remove a public-key certificate corresponding to the user information from a certificate subdomain and store the public-key certificate contained in the DNSSEC request into the certificate subdomain or forward the DNSSEC request to another DNSSEC server in order that the public-key certificate corresponding to the user information is removed from the certificate subdomain and that the public-key certificate contained in the DNSSEC request is stored into the certificate subdomain.

6. The public-key-certificate publishing system of claim 1
wherein the public-key-certificate-related request is a revoke request; and
wherein the publisher service extracts user information contained in the revoke request, creates a DNSSEC request that contains the extracts user information, and transmits the DNSSEC request to a DNSSEC server in order to direct the DNSSEC server to mark a public-key certificate corresponding to the user information as or to forward the DNSSEC request to another DNSSEC server in order that the public-key certificate corresponding to the user information is marked as revoked.

7. A public-key-certificate publishing system of claim 1 further comprising:
prior to transmitting the public-key-certificate-related request to the remote publisher service, the client-side publisher component undertakes a handshake operation to establish a secure communication with the publisher service.

8. A public-key-certificate publishing system of claim 7 wherein the handshake operation comprises:
establishing a first secure transport layer connection with the publisher service;
receiving, from the publisher service by the client-side publisher component, a first transaction ID;
storing the received first transaction ID and a first-secure-transport-layer session key by the client-side publisher component;
receiving, from the publisher service by the client-side publisher component, a second transaction ID through a different communications medium that that through which the first transaction ID was received;
storing the received second transaction ID with the already stored first transaction ID and first-secure-transport-layer session key;
establishing a second secure transport layer connection with the publisher service;
retrieving the stored second transaction ID, first transaction ID, and first-secure-transport-layer session key and transmitting the retrieved second transaction ID, first transaction ID, and first-secure-transport-layer session key to the publisher service, which compares the transmitted second transaction ID, first transaction ID, and first-secure-transport-layer session key to a second transaction ID, first transaction ID, and first-secure-transport-layer session key stored by the publisher service; and
when the transmitted second transaction ID, first transaction ID, and first-secure-transport-layer session key match the second transaction ID, first transaction ID, and first-secure-transport-layer session key stored by the publisher service, receiving, from the publisher service an indication to proceed with the public-key-certificate-related request.

9. A public-key-certificate publishing system comprising:
a publisher service implemented as a hardware appliance or executed on a computer system, such as a DNSSEC server, that includes one or more processors and an electronic memory and that receives a public-key-certificate-related request, stores the public-key-certificate-related request in the electronic memory, and executes the public-key-certificate-related request by:
creating at least one DNSSEC request, and
transmitting the at least one DNSSEC request to a DNSSEC server for execution by the DNSSEC server.

10. The public-key-certificate publishing system of claim 9
wherein the public-key-certificate-related request is a publish request; and
wherein the publisher service extracts a public-key certificate contained in the publish request, creates a DNSSEC request that contains the extracted public-key certificate, and transmits the DNSSEC request to DNSSEC server to direct the DNSSEC server to store the public-key certificate into a certificate subdomain or forward the DNSSEC request to another DNSSEC server in order that the public-key certificate is stored in the certificate subdomain.

11. The public-key-certificate publishing system of claim 9
wherein the public-key-certificate-related request is a create request; and
wherein the publisher service extracts user information contained in the create request, generates a new public/private encryption key, creates a public-key certificate for the client-side publisher component, creates a DNSSEC request that contains the created public-key certificate, transmits the DNSSEC request to DNSSEC server to direct the DNSSEC server to store the public-key certificate into a certificate subdomain or forward the DNSSEC request to another DNSSEC server in order that the public-key certificate is stored in the certificate subdomain, and returns the generated private encryption key to the system that transmitted the public-key-certificate-related request to the publisher service.

12. The public-key-certificate publishing system of claim 9
wherein the public-key-certificate-related request is a confirm request; and
wherein the publisher service extracts public-key-certificate identifying information contained in the confirm request, creates a DNSSEC request that contains extracted public-key-certificate identifying information, transmits the DNSSEC request to DNSSEC server to direct the DNSSEC server to return the public-key certificate corresponding to the public-key-certificate identifying information or forward the DNSSEC request to another DNSSEC server in order that the public-key certificate is returned, and, when a valid and unrevoked public-key certificate is returned by a DNSSEC server in response to the transmitted DNSSEC request, returns, to the system that transmitted the public-key-certificate-related request to the publisher service, an indication that the identified public-key certificate is valid and unrevoked.

13. The public-key-certificate publishing system of claim 9
wherein the public-key-certificate-related request is an update request; and
wherein the publisher service extracts user information contained in the update request, generates a new public/private encryption key, creates a public-key certificate for the client-side publisher component, creates a DNSSEC request that contains the created public-key certificate, transmits the DNSSEC request to DNSSEC server to direct the DNSSEC server to remove a public-key certificate corresponding to the user information from a certificate subdomain and store the public-key certificate contained in the DNSSEC request into the certificate subdomain or forward the DNSSEC request to another DNSSEC server in order that the public-key certificate corresponding to the user information is removed from the certificate subdomain and that the public-key certificate contained in the DNSSEC request is stored into the certificate subdomain.

14. The public-key-certificate publishing system of claim 9
wherein the public-key-certificate-related request is a revoke request; and
wherein the publisher service extracts user information contained in the revoke request, creates a DNSSEC request that contains the extracts user information, and transmits the DNSSEC request to a DNSSEC server in order to direct the DNSSEC server to mark a public-key certificate corresponding to the user information as or to forward the DNSSEC request to another DNSSEC server in order that the public-key certificate corresponding to the user information is marked as revoked.

15. A digital certificate resolving system comprising:
a client-side component, executed on one or more processors of a client computer system stored in an electronic memory within the client computer system, that, in response to receiving a digitally signed message M from a sender system,
transmits a request for a public-key certificate published for the sender to a DNSSEC server;
when the DNSSEC server fails to return the requested public-key certificate, returns a failure indication; and
when the DNSSEC server returns the requested public-key certificate, evaluates the digital signature using the returned public key, and returns a success or failure corresponding to the outcome of this evaluation of the digital signature.

16. The digital certificate resolving system of claim 15 wherein the evaluation of the digital signature comprises:
extracting clear-text message m and encrypted digest d from the message M;
generating a digest d′ from the clear-text message m;
generating an encrypted digest d′ digest d′ using the public key contained in the returned public-key certificate;
returning success when the encrypted digest d′ is identical to encrypted digest d; and
returning failure when the encrypted digest d′ is not identical to encrypted digest d.

17. A method for eliminating phishing and SPAM emails, the method comprising:
discarding all non-signed received emails;
for all signed received emails,
authenticating the email senders' identity by utilizing the email sender's public key published in a DNSSEC name server.
